(19) United States
(12) Patent Application Publication
(10) Pub. No.: US 2023/0252292 A1
(43) Pub. Date: Aug. 10, 2023

(54) METHOD OF PROVIDING INFORMATION ON NEURAL NETWORK MODEL AND ELECTRONIC APPARATUS FOR PERFORMING THE SAME

(71) Applicant: NOTA, INC., Daejeon (KR)

(72) Inventors: Yoo Chan KIM, Seoul (KR); Ji Na SHIN, Seoul (KR); Ho In NA, Seoul (KR); Chae Hyuk LEE, Seoul (KR); Dong Wook KIM, Seoul (KR); Jong Won BAEK, Uiwang-si (KR); Cheol Bin PARK, Seoul (KR); Sun Joo PARK, Seoul (KR)

(21) Appl. No.: 18/163,242

(22) Filed: Feb. 1, 2023

(30) Foreign Application Priority Data
Feb. 10, 2022 (KR) 10-2022-0017230
Feb. 10, 2022 (KR) 10-2022-0017231
Feb. 23, 2022 (KR) 10-2022-0023385
Apr. 19, 2022 (KR) 10-2022-0048201
May 11, 2022 (KR) 10-2022-0057599
Aug. 19, 2022 (KR) 10-2022-0104351
Aug. 19, 2022 (KR) 10-2022-0104352

(51) Int. Cl. G06N 3/08

(52) U.S. Cl. CPC G06N 3/08

(57) ABSTRACT

Disclosed is a method of providing information on a neural network model. The method includes receiving information on a target device and target performance of the neural network model; deriving information on a plurality of candidate neural network models; and transmitting a command to the external device to display information on the plurality of candidate neural network models, wherein the information on the plurality of candidate neural network models includes at least one of name of the plurality of candidate neural network models, performance of the plurality of candidate neural network models, or size of input data of the plurality of candidate neural network models.

### CROSS-REFERENCE TO RELATED APPLICATIONS

This application claims priority from Korean Patent Application No. 10-2022-0017230 filed in the Korean Intellectual Property Office on Feb. 10, 2022, Korean Patent Application No. 10-2022-0017231 filed in the Korean Intellectual Property Office on Feb. 10, 2022, Korean Patent Application No. 10-2022-0023385 filed in the Korean Intellectual Property Office on Feb. 23, 2022, Korean Patent Application No. 10-2022-0048201 filed in the Korean Intellectual Property Office on Apr. 19, 2022, Korean Patent Application No. 10-2022-0057599 filed in the Korean Intellectual Property Office on May 11, 2022, Korean Patent Application No. 10-2022-0104351 filed in the Korean Intellectual Property Office on Aug. 19, 2022, and Korean Patent Application No. 10-2022-0104352 filed in the Korean Intellectual Property Office on Aug. 19, 2022, the disclosures of which are incorporated herein by reference.

### BACKGROUND

### Field of the Invention

The present disclosure relates to a method of providing information on a neural network model and an electronic apparatus for performing the same.

### Discussion of Related Art

With the spread of artificial intelligence technology, the needs of users who need an artificial intelligence model to run an artificial intelligence model in a target device are increasing. Although various artificial intelligence models are being released around the world, it is not easy for users to directly find an artificial intelligence model that has performance that they want. In addition, even if users find models with excellent performance such as a state-of-the-art (SOTA) model, the models are not necessarily operable on a target device. For this reason, users have trouble of checking whether the models can be run on the target device.

Accordingly, there is a need for a technology of allowing users to conveniently acquire a neural network model optimized for a target device.

### SUMMARY OF THE INVENTION

The present disclosure provides an electronic apparatus that provides a neural network model optimized for a target device.

The present disclosure also provides an electronic apparatus that provides a neural network model trained based on a data set input by a user.

The present disclosure also provides an electronic apparatus that provides a compressed neural network model trained based on a compression configuring value input by a user.

The present disclosure also provides an electronic apparatus that provides download data corresponding to a compressed neural network model.

Objects of the present disclosure are not limited to the above-mentioned objects. That is, other objects that are not described may be obviously understood by those skilled in the art to which the present disclosure pertains from the following description.

The present disclosure may provide a method for providing information on a neural network model, performed by an electronic apparatus, comprising: receiving, at a processor of the electronic apparatus, information on a target device on which the neural network model will be executed and target performance of the neural network model for the target device from an external device; deriving, by the processor, information on a plurality of candidate neural network models based on the information on the target device and the received target performance; and transmitting, via a computer network, a command to the external device to display information on the plurality of candidate neural network models based on the received target performance, wherein the information on the plurality of candidate neural network models includes at least one of name of the plurality of candidate neural network models, performance of the plurality of candidate neural network models, or size of input data of the plurality of candidate neural network models.

When a training mode for deriving the plurality of candidate neural network models is configured as a first training mode, a plurality of UI elements each representing information on the plurality of candidate neural network models may include first UI elements each corresponding to a respective one of a plurality of first candidate neural network models derived based on size of input data configured by the user and second UI elements each corresponding to a respective one of a plurality of second candidate neural network models derived based on target performance configured by a user. The first UI elements and the second UI elements may be displayed in different areas. When a training mode is configured as a second training mode, the plurality of UI elements may be displayed on a two-dimensional graph defined by a first axis corresponding to a first performance parameter and a second axis corresponding to a second performance parameter, the second axis being perpendicular to the first axis.

When the training mode is configured as the first training mode, the plurality of UI elements may be displayed in order of decreasing difference between the performance of the candidate neural network model corresponding to each of the plurality of UI elements and the received target performance.

The first performance parameter may be a latency, and the second performance parameter may be an accuracy.

The plurality of UI elements may include third UI elements each corresponding to a respective one of a plurality of third candidate neural network models having performance within a predetermined range from the received target performance, and fourth UI elements corresponding to a plurality of fourth candidate neural network models having performances outside the predetermined range from the received target performance. The transmitting may include transmitting a command to the external device to activate the third UI elements and deactivate the fourth UI elements.

Each of the plurality of UI elements may display information on the plurality of candidate neural network models when selected by a user.

The information on the plurality of candidate neural network models may be obtained based on a look-up table. The look-up table may include identification information of a plurality of neural network models, information on a plurality of devices on which the plurality of neural network models are executed, and performance information of the plurality of neural network models for the plurality of devices.

The deriving may include deriving information on neural network models whose rankings are higher than or equal to a predetermined ranking among the plurality of neural network models, the rankings being based on performance differences from the target performance.

The deriving may include deriving information on neural network models whose difference from the target performance is within a preset range among the plurality of neural network models.

The present disclosure may provide an electronic apparatus for providing information on a neural network model, comprising: a communication interface configured to transmit and receive data via a data network, including at least one communication circuit; a non-transitory memory configured to store at least one operation instruction; and a processor, wherein execution of the at least one operation instruction causes the processor to: receive information on a target device on which the neural network model will be executed and target performance of the neural network model for the target device from an external device; derive information on a plurality of candidate neural network models based on the information on the target device and the received target performance; and transmit a command to the external device to display information on the plurality of candidate neural network models based on the received target performance, wherein the information on the plurality of candidate neural network models includes at least one of name of the plurality of candidate neural network models, performance of the plurality of candidate neural network models, or size of input data of the plurality of candidate neural network models. When a training mode for deriving the plurality of candidate neural network models is configured as a first training mode, a plurality of UI elements each representing information on the plurality of candidate neural network models may include first UI elements each corresponding to a respective one of a plurality of first candidate neural network models derived based on size of input data configured by the user and second UI elements each corresponding to a respective one of a plurality of second candidate neural network models derived based on target performance configured by a user. The first UI elements and the second UI elements may be displayed in different areas. When a training mode is configured as a second training mode, the plurality of UI elements may be displayed on a two-dimensional graph defined by a first axis corresponding to a first performance parameter and a second axis corresponding to a second performance parameter, the second axis being perpendicular to the first axis.

When the training mode is configured as the first training mode, the plurality of UI elements may be displayed in order of decreasing difference between the performance of the candidate neural network model corresponding to each of the plurality of UI elements and the received target performance.

The plurality of UI elements may include third UI elements each corresponding to a respective one of a plurality of third candidate neural network models having performance within a predetermined range from the received target performance, and fourth UI elements corresponding to a plurality of fourth candidate neural network models having performances outside the predetermined range from the received target performance.

The processor may control the communication interface to transmit a command to the external device to activate the third UI elements and deactivate the fourth UI elements.

The processor may derive the information on the plurality of candidate neural network models based on a look-up table. The look-up table may include identification information of a plurality of neural network models, information on a plurality of devices on which the plurality of neural network models are executed, and performance information of the plurality of neural network models for the plurality of devices.

The processor may derive information on neural network models whose rankings are higher than or equal to a predetermined ranking among the plurality of neural network models, the rankings being based on performance differences from the target performance.

The processor may derive information on neural network models whose difference from the target performance is within a preset range among the plurality of neural network models.

Technical solutions of the present disclosure are not limited to the abovementioned solutions, and solutions that are not mentioned will be clearly understood by those skilled in the art to which the present disclosure pertains from the present specification and the accompanying drawings.

### BRIEF DESCRIPTION OF THE DRAWINGS

Aspects, features, and advantages of specific embodiments of the present disclosure will become more apparent from the following description with reference to the accompanying drawings:

FIG. 1 is a diagram showing an operation of an electronic apparatus in accordance with embodiments of the present disclosure;

FIG. 2 is a block diagram showing a configuration of an electronic apparatus in accordance with embodiments of the present disclosure;

FIG. 3 is a diagram showing a method of performing a first project in accordance with embodiments of the present disclosure;

FIG. 4 is a diagram showing a method of performing a second project in accordance with embodiments of the present disclosure;

FIG. 5 is a diagram showing a method of performing a third project in accordance with embodiments of the present disclosure;

FIG. 6 is a diagram showing a data set input screen in accordance with embodiments of the present disclosure;

FIG. 7 is a diagram showing a data set confirmation screen in accordance with embodiments of the present disclosure;

FIG. 8 is a diagram showing a data set list screen in accordance with embodiments of the present disclosure;

FIG. 9 is a diagram showing a target device input screen in accordance with embodiments of the present disclosure;

FIG. 10 is a diagram showing a project information screen in accordance with embodiments of the present disclosure;

FIG. 11 is a diagram showing a method of controlling an electronic apparatus in accordance with embodiments of the present disclosure;

FIG. 12 is a sequence diagram showing a method of performing a first project in accordance with embodiments of the present disclosure;

FIG. 13 is a sequence diagram showing a method of performing a second project in accordance with embodiments of the present disclosure;

FIG. 14 is a sequence diagram showing a method of performing a third project in accordance with embodiments of the present disclosure;

FIG. 15 is a block diagram showing a configuration of a system for providing a neural network model in accordance with embodiments of the present disclosure;

FIG. 16 is a diagram showing a learning setting screen in accordance with embodiments of the present disclosure;

FIG. 17 is a diagram showing a base model recommendation screen in accordance with embodiments of the present disclosure;

FIG. 18 is a diagram showing a method of displaying information on a neural network model via a user interface screen in accordance with embodiments of the present disclosure;

FIG. 19 is a diagram showing a method of displaying information on a neural network model in accordance with embodiments of the present disclosure;

FIG. 20 is a diagram showing a method of acquiring performance data of a neural network model in accordance with embodiments of the present disclosure;

FIG. 21 is a diagram showing a method of controlling an electronic apparatus in accordance with embodiments of the present disclosure;

FIG. 22 is a diagram showing an operation of an electronic apparatus in accordance with embodiments of the present disclosure;

### DETAILED DESCRIPTION OF EXEMPLARY EMBODIMENTS

Terms used in the present specification will be briefly described, and then the present disclosure will be described in detail.

General terms that are currently widely used are selected as terms used in embodiments of the present disclosure in consideration of functions in the present disclosure, but may be changed depending on the intention of those skilled in the art or a judicial precedent, the emergence of a new technique, and the like. In addition, in a specific case, terms arbitrarily chosen by an applicant may be used. In this case, the meaning of such terms will be mentioned in detail in a corresponding description portion of the present disclosure. Therefore, the terms used in the present disclosure should be defined on the basis of the meaning of the terms and the contents throughout the present disclosure rather than simple names of the terms.

The present disclosure may be variously modified and have several embodiments, and therefore specific embodiments of the present disclosure will be illustrated in the accompanying drawings and given in detail in the detailed description. However, it is to be understood that the present disclosure is not limited to specific exemplary embodiments, but includes all modifications, equivalents, and substitutions without departing from the scope and spirit of the present disclosure. When it is determined that a detailed description of the known art related to the present disclosure may obscure the gist of the present disclosure, the detailed description will be omitted.

Terms “first,” “second,” and the like, may be used to describe various components, but the components are not to be construed as being limited by these terms. The terms are used only to distinguish one component from another component.

Singular forms are intended to include plural forms unless the context clearly indicates otherwise. More specifically, as used herein and in the appended claims, the singular forms “a,” “an,” “said,” and “the” include plural referents unless the context clearly dictates otherwise. It should be understood that terms “comprise” and “include” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

Hereinafter, embodiments of the present disclosure will be described in detail with reference to the accompanying drawings so that those skilled in the art to which the present disclosure pertains may easily practice the present disclosure. However, the present disclosure may be modified in various different forms, and is not limited to the embodiments described herein. In addition, in the drawings, portions unrelated to the description will be omitted to obviously describe the disclosure, and similar reference numerals will be used to describe similar portions throughout the specification.

The details of embodiments set forth herein, both as to structure and operation, are provided in the accompanying figures, in which like reference numerals refer to like or corresponding elements among the various views. The elements in the figures are not necessarily to scale, emphasis instead being placed upon illustrating the principles of the embodiments. Moreover, all illustrations are intended to convey concepts, where relative sizes, shapes and other detailed attributes may be illustrated schematically rather than literally or precisely.

The present disclosure may provide a method of acquiring a neural network model that is performed by a computing device, comprising: receiving, at a processor of the computing device, a data set for training a neural network model, information regarding a target device for executing the neural network model, and a training mode for the neural network model; configuring a project using the processor based on the data set, the information regarding the target device, and the training mode; and deriving at least one trained neural network model by performing the configured project.

When a first set of data is received as the data set and a first training mode is received as the training mode, the project is configured as a first project and a first trained model is derived by performing the configured first project. The performing the configured first project may comprise: identifying a plurality of base models among a plurality of neural network models pre-stored in a memory based on the information regarding the target device and target performance input by a user; and deriving the first trained model by training a first base model based on the first set of data. The first base model may be selected by the user from the plurality of identified base models.

The plurality of identified base models may be neural network models that correspond to the target device and whose differences in performance from the target performance are within a preset range. The plurality of base models may be identified based on a look-up table that includes identification information for the plurality of pre-stored neural network models, the information on the target device, and performance information for the plurality of neural network models derived by executing an associated one of the plurality of neural network models on the target device.

When a second set of data is received as the data set and a second training mode is received as the training mode, the project may be configured as a second project and a second trained model is derived by performing the configured second project. The performing the configured second project may include: deriving a second base model based on the information regarding the target device and a predefined algorithm; and deriving the second trained model by training the second base model based on the second set of data.

The predefined algorithm may include at least one of a hyper-parameter optimization (HPO) algorithm or a neural architecture search (NAS) algorithm.

The method may comprise storing the at least one trained neural network model in a model database.

When a third set of data is received as the data set and a third training mode is received as the training mode, the project is configured as a third project and a third trained model derived by performing the set third project. The performing the set third project may include: providing a model list including at least one trained model derived from the model database to a user; and deriving the third trained model based on a trained model selected by the user from the model list and the third set of data. The third trained model may be trained based on the third set of data.

The method may comprise: identifying whether a format of the data set is a preset format; and converting the format of the data set into the preset format when the format of the data set is not the preset format.

The preset format may include a format of You only look once (YOLO).

The performance information of the plurality of neural network models included in the look-up table may be derived by executing the plurality of neural network models using the target device.

The present disclosure may provide an electronic apparatus for acquiring a neural network model, comprising: a communication interface operable to transmit and receive data via a communications network and including at least one communication circuit; a non-transitory computer readable memory configured to store at least one instruction; and a processor, wherein execution of the processor executes the at least one operation instruction causes the processor to: receives a data set for training a neural network model, information about a target device for executing the neural network model, and a training mode for the neural network model; configures a project based on the data set, the information on the target device, and the training mode; and derives at least one trained neural network model by performing the configured project.

The processor may configure a first project based on a first set of data, the information on the target device, and a first training mode. When the configured first project is performed, the processor may identify a plurality of base models among a plurality of neural network models pre-stored in the memory based on the information on the target device and target performance input from a user; control the communication interface to transmit a command to an external device that causes the external device to display information regarding the plurality of base models; and derive a first trained model trained based on the first set of data and a first base model selected by the user from the plurality of base models.

The plurality of identified base models may be neural network models that correspond to the target device and have differences in performance from the target performance within a preset range. The plurality of identified base models may be identified based on a look-up table stored in the memory. The look-up table may include identification information about the plurality of pre-stored neural network models, the information about the target device, and performance information about the plurality of neural network models derived by executing an associated one of the plurality of neural network models on the target device.

The processor may configure a second project based on a second set of data, the information about the target device, and a second training mode. When the configured second project is performed, the processor may derive a second base model based on the information on the target device and a predefined algorithm; and derive a second trained model by training the second base model based on the second set of data.

The predefined algorithm may include at least one of a hyperparameter optimization algorithm (HPO) or a neural network architecture (NAS) search algorithm.

The processor may cause the at least one trained neural network model to be stored in a model database.

The processor may configure a third project based on a third set of data, the information about the target device, and a third training mode. When the configured third project is performed, the processor may provide a model list including at least one trained model from the model database; and derive a third trained model trained based on the third set of data by training the trained model selected by the user from the model list.

The processor may identify whether a format of the data set is a preset format. When the format of the data set is not the preset format, the processor may convert the format of the data set into the preset format.

The performance information about the plurality of neural network models included in the look-up table may be derived by executing the plurality of neural network models using the target device.

The present disclosure may provide a method for providing a neural network model that is performed by a computing device, comprising: receiving, at a processor of the computing device, a trained model that has been trained based on a data set and a target device identified in a device farm using information about the target device that has been inputted by a user; compressing the trained model based on compression configuring information and latency information received from the device farm; and providing download data corresponding to the compressed trained model so that the compressed trained model is deployed on the target device.

The compression configuring information may include a first compression mode indicating that the trained model is compressed based on a model compression configuring value that is set by the user. When the first compression mode is configured, the compressing the trained model may comprise: identifying a plurality of compressible target blocks among a plurality of blocks included in the trained model; deriving a first set of compression parameters, including block compression configuring values for block compression applied to a respective one of the plurality of target blocks, based on both the model compression configuring value and a predefined algorithm; and compressing the plurality of compressible target blocks based on the first set of compression parameters.

The compressing the trained model may further comprise providing the first set of compression parameters to the user. When the block compression configuring values is modified by the user, the compressing the trained model may further comprise compressing the plurality of target blocks based on a second set of compression parameters including the modified block compression configuring values.

The compression configuring information may include a second compression mode indicating that information on a block included in the trained model is provided and the trained model is compressed based on block compression configuring values set by the user. When the second compression mode is configured, the compressing may comprise: identifying a plurality of compressible target blocks among a plurality of blocks included in the trained model; providing information on the plurality of target blocks to the user; receiving a set of third compression parameters including the block compression configuring values applied to a respective one of the plurality of target blocks, where the block compression configuring values have been set by the user for the compression of the plurality of target blocks; and compressing the plurality of target blocks based on the set of third compression parameters.

The information on the block included in the training model may include at least one of identification information of the block, a latency corresponding to the block, or a quantity of channels included in the block.

The compressing the trained model may further comprise: receiving a plurality of latency data from the target device, wherein each latency data of the plurality of latency data may be associated with a respective one block of the plurality of blocks, wherein each latency data of the plurality of latency data may be derived by executing an associated block of the plurality of blocks by the target device.

The compression configuring information may include at least one of compression methods, compression configuring values, or reference information for determining a compression target among a plurality of channels included in the trained model.

The method may further comprise: receiving, at the processor, a user command for retraining the compressed trained model; generating a retrained model based on the compressed trained model, and providing download data corresponding to the retrained model.

The method may further comprise: performing, at the processor, at least one quantization or calibration operation on the compressed trained model based on the information about the target device.

The present disclosure may provide an electronic apparatus for providing a neural network model, comprising: a communication interface, configured to send and receive data via a data network, including at least one communication circuit; a memory configured to store at least one operation instruction; and a processor, wherein execution of the at least one operation instruction causes the processor to: receive a trained model that has been trained based on a data set and a target device identified in a device farm using information about the target device that has been inputted by a user; compress the trained model based on compression configuring information and latency information received from the device farm; and provide download data corresponding to the compressed trained model so that the compressed trained model is deployed on the target device.

The compression configuring information may include a compression mode indicating that the trained model is compressed based on a model compression configuring value that is configured by the user. When the first compression mode is configured, the processor may identify a plurality of compressible target blocks among a plurality of blocks included in the trained model, derive a first set of compression parameters, including block compression configuring values for block compression applied to a respective one of the plurality of target blocks based on both the model compression configuring value and a predefined algorithm, and compress the plurality of compressible target blocks based on the first set of compression parameters.

The processor may provide the first set of compression parameters to the user. When at least one of the block compression configuring values is modified by the user, the processor may compress the plurality of target blocks based on a second set of compression parameters including the modified at least one of the block compression configuring values.

The compression configuring information includes a second compression mode indicating that information on a block included in the trained model is provided. The trained model may be compressed based on block compression configuring values configured by the user. When the second compression mode is configured, the processor may identify a plurality of compressible target blocks among a plurality of blocks included in the trained model, provide information on the plurality of target blocks to the user, receive a set of third compression parameters including the block compression configuring values applied to a respective one of the plurality of target blocks, where the block compression configuring values have been configured by the user for the compression of the plurality of target blocks, and compress the plurality of target blocks based on the set of third compression parameters.

The information on the block included in the training module may include at least one of identification information of the block, a latency corresponding to the block, or a quantity of channels included in the block.

The processor may receive a plurality of latency data from the target device. Each latency data of the plurality of latency data may be associated with a respective one block of the plurality of blocks. Each latency data may be derived by executing an associated block of the plurality of blocks by the target device.

The compression configuring information may include at least one of a compression method, a compression configuring values, or reference information for determining a compression target among a plurality of channels included in the trained model.

The processor may receive a user command for retraining the compressed trained model, generate a retrained model based on the compressed trained model, and provide download data corresponding to the retrained model.

The processor may quantize or calibrate the compressed trained model based on the information about the target device.

The processor may determine a compression configuring value of the trained model based on the latency information.

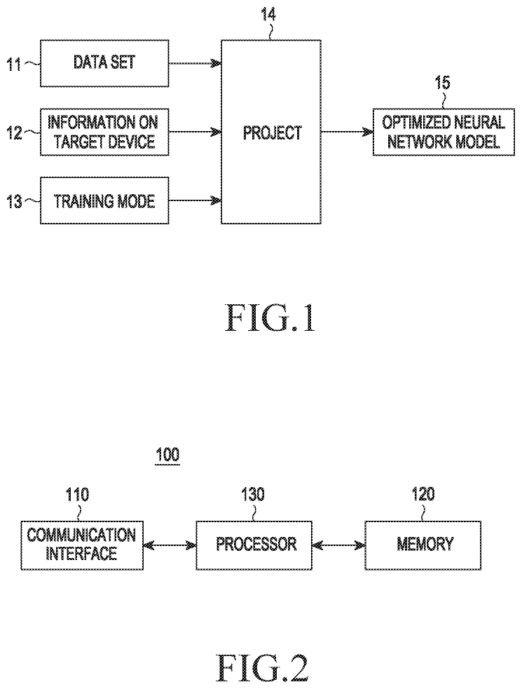

FIG. 1 is a diagram for describing an operation of an electronic apparatus according to an embodiment of the present disclosure.

Referring to FIG. 1, an electronic apparatus 100 may define a project 14 based on a data set 11, information 12 on a target device, and a training mode 13. The project 14 may mean a business unit for acquiring a neural network model 15 optimized for the target device. The electronic apparatus 100 may derive the optimized neural network model 15 by performing the project 14. The electronic apparatus 100 may provide the optimized neural network model to a user.

The data set 11 may include various types of data used to train the neural network model 15. For example, the data set 11 may include training data used to train the neural network model 15, validation data used to evaluate performance of the neural network model while the training of the neural network model 15 is in progress, and test data used to evaluate the performance of the neural network model 15 after the training of the neural network model 15 is completed.

The information 12 on the target device may include various types of information related to the target device. The information 12 on the target device may include model information on the target device and software of the target device.

The training mode 13 may include a first training mode, a second training mode, and a third training mode. The first training mode is a mode for training a model selected by a user from a plurality of pre-stored base models. The second training mode is a mode for training a model derived based on a predefined algorithm. The third training mode is a mode for retraining the trained model in the first training mode or the second training mode. For example, the first training mode is a so-called ‘simple mode’ and may be a mode in which a user can obtain a trained model with a minimum amount of time. The second training mode is a so-called ‘expert mode’ and takes more time than the first training mode, but may be a mode capable of obtaining a trained model with better performance (or closer to the target performance configured by the user). Also, in the second training mode, a larger number of models may be provided than in the first training mode. For example, in the first training mode, one model is obtained by performing a project once, whereas in the second training mode, a plurality of models of two or more may be derived by performing a project once.

The electronic apparatus 100 may define the project 14 based on the data set 11, the information 12 on the target device, the training mode 13, and the information on the neural network model 15. The information on the neural network model 15 may include a framework of the neural network model 15, an output data type (e.g., 32-bit floating point), and an inference batch size.

FIG. 2 is a block diagram illustrating a configuration of the electronic apparatus according to the embodiment of the disclosure.

Referring to FIG. 2, the electronic apparatus 100 may include a communication interface 110, a memory 120, and a processor 130. For example, the electronic apparatus 100 may be implemented as a physical server or a cloud server.

The communication interface 110 includes at least one communication circuit and may communicate with various types of external devices. For example, the communication interface 110 may receive information on a data set and a target device from an external device. The external device may be a user device. The user device may include personal computers and mobile devices. The communication interface 110 may transmit information on a plurality of base models retrieved based on the information on the target device to the external device. Accordingly, the external device may output the information on the plurality of base models. The communication interface 110 may receive a user command for selecting at least one of the plurality of base models from the external device.

The communication interface 110 may transmit at least one selected base model and data set to an external server. The external server may acquire a trained neural network model (or trained model) after training at least one base model selected using the data set. The communication interface 110 may receive a trained model from the external server.

The communication interface 110 may transmit the trained model to the external device. The communication interface 110 may transmit information on the trained model to the external device. The information on the trained model may include a name of the trained model, a task performed by the trained model, information on a target device corresponding to the trained model, and performance (e.g., accuracy and latency) of the trained model. Meanwhile, in the present disclosure, acquiring/storing/transmitting/receiving a neural network model means acquiring/storing/transmitting/receiving data (e.g., architecture, weight) related to a model.

The communication interface 110 may include at least one of a Wi-Fi communication module, a cellular communication module, a 3rd generation (3G) mobile communication module, a 4th generation (4G) mobile communication module, a 4th generation long term evolution (LTE) communication module, a 5th generation (5G) mobile communication, or wired Ethernet.

The memory 120 may store an operating system (OS) for controlling an overall operation of the components of the electronic apparatus 100 and commands or data related to the components of the electronic apparatus 100. The memory 120 may be implemented as a non-volatile memory (e.g., a hard disk, a solid state drive (SSD), and a flash memory), a volatile memory, or the like.

The memory 120 may include a database (DB). For example, the memory 120 may include a data set DB for storing a data set. The memory 120 may include a project DB for storing a project. The memory 120 may include a model DB for storing the trained model. The information stored in the DB may be provided to a user. For example, a data set list, a project list, and/or a model list may be displayed on an external device.

The memory 120 may store information on a plurality of neural network models. For example, the memory 120 may store a look-up table in which identification information of a plurality of neural network models, information on a target device, and performance information of a plurality of neural network models are matched. The performance information of the plurality of neural network models may reflect performance (e.g., latency) of each of the plurality of neural network models when the neural network models are executed in the target device. The performance of the neural network model for the target device may be the performance of the neural network model when the neural network model is executed in the target device. The latency of the neural network model may be acquired from a device farm. The accuracy of the neural network model may be acquired using test data.

The memory 120 may store a predefined algorithm for searching for the base model. The predefined algorithm may include at least one of a hyper-parameter optimization (HPO) algorithm or a neural architecture search (NAS) algorithm. The hyper-parameter optimization algorithm may include a tree-structured parzen estimator (TPE) algorithm. The TPE algorithm may be based on Bayesian optimization. The neural network architecture search algorithm may be based on an evolutionary algorithm.

The processor 130 may be electrically connected to the memory 120 to control overall operations and functions of the electronic apparatus 100. The processor 130 may control the electronic apparatus 100 by executing instructions stored in the memory 120.

The processor 130 may receive the data set, the information on the target device, and the training mode. The processor 130 may receive the data set, the information on the target device, and the training mode from the external device through the communication interface 110. The data set, the information on the target device, and the training mode may be input to the external device by a user.

The processor 130 may identify whether the format of the data set is a preset format. When the format of the data set is not the preset format, the processor 130 may convert the format of the data set into the preset format. The processor 130 may store the data set whose format is converted in the memory 120. The preset format may include a format of You only look once (YOLO).

The processor 130 may configure a project based on the data set, the information on the target device, and the training mode. The project may mean a task unit for acquiring the trained neural network model optimized for the target device. For example, the processor 130 may configure a first project based on a first set of data, information on a first target device, and a first training mode. The processor 130 may configure a second project based on a second set of data, information on a second target device, and a second training mode. The processor 130 may configure a third project based on a third set of data, information on a third target device, and a third training mode.

The processor 130 may derive a neural network model by performing a project. For example, the processor 130 may perform the first project. In this case, the processor 130 may identify the plurality of base models based on the information on the target device and the target performance configured by the user. For example, the processor 130 may identify a plurality of base models based on the look-up table stored in the memory 120. In the look-up table, identification information of a plurality of neural network models, the information on the target device, and performance information of the plurality of neural network models may be matched. The performance information of the plurality of neural network models may reflect performance (e.g., latency) of each of the plurality of neural network models when the neural network models are executed in the target device. The processor 130 may receive the performance of each of the plurality of neural network models from the device farm. Alternatively, the processor 130 may acquire the performance of some of the plurality of neural network models using the device farm, and may acquire the performance of some of the remaining neural network models using the trained neural network model to predict the latency.

When performing the first project, the processor 130 may identify, as a base model, a neural network model, which corresponds to the target device and has a difference in performance from the target performance within a preset range, based on the look-up table. For example, the processor 130 may identify a plurality of base models having a difference in latency from a target latency within 0.1 seconds.

The processor 130 may control the communication interface 110 to transmit the information on the plurality of base models to the external device. The external device may provide the information on the plurality of base models to the user. For example, the information on the plurality of base models may include identification information (e.g., model name), latency, and a size of input data of each of the plurality of base models. The external device may receive a user command for selecting a first base model from the plurality of base models. The processor 130 may receive a user command from the external device through the communication interface 110. In the various embodiments described herein, providing data to a user can be via display on a user interface of a computing device and/or in a computer readable data structure.

The processor 130 may control the communication interface 110 to transmit the first base model and the first set of data to the external server. In addition, the processor 130 may control the communication interface 110 to transmit learning configuring information on the first base model to the external server. The learning configuring information may include a size of input data (e.g., resolution of an input image), a training epoch, and data augmentation of the trained model. The external server may acquire the first trained model by training the first base model using the first set of data based on the learning configuring information. The processor 130 may receive the first trained model from the external server.

The processor 130 may perform the second project. In this case, the processor 130 may acquire a plurality of base models based on a predefined algorithm. The processor 130 may control the communication interface 110 to transmit the information on the plurality of base models to the external device. The external device may provide the information on the plurality of base models to the user. The external device may receive a user command for selecting a second base model from the plurality of base models. Alternatively, the processor 130 may select a plurality of second base models from the plurality of base models based on the target performance configured by the user. For example, the processor 130 may select the plurality of second base models having performance within a target accuracy range and a target latency range configured by a user.

The processor 130 may control the communication interface 110 to transmit the plurality of second base models, the second set of data, and the learning configuring information to the external server. The external server may acquire a plurality of second trained models by training each of the plurality of second base models using the second set of data based on the learning configuring information. The processor 130 may receive the plurality of second trained models from the external server.

The processor 130 may perform a third project. The processor 130 may perform the first project or the second project, and then perform the third project. For example, the processor 130 may perform the first project, and then perform the third project. The processor 130 may control the communication interface 110 to transmit the third set of data and retraining configuring information for retraining the first trained model to the external server. The external server may acquire a third trained model by training the first base model using the third set of data based on the retraining configuring information. The processor 130 may receive the third trained model from the external server.

Meanwhile, functions related to artificial intelligence (AI) according to the present disclosure are operated through the processor 130 and the memory 120. The processor 130 may include one or a plurality of processors. In this case, one or the plurality of processors may be general purpose processors such as a central processing unit (CPU), an application processor (AP), and a digital signal processor (DSP), graphics dedicated processors such as a graphics processing unit (GPU), a vision processing unit (VPU), or an artificial intelligence dedicated processor such as a neural processing unit (NPU). One processor or the plurality of processors control to process input data according to a predefined operation rule or an AI model stored in the memory 120. Alternatively, when one or the plurality of processors are an artificial intelligence dedicated processor, the artificial intelligence dedicated processor may be designed with a hardware structure specialized for processing a specific AI model.

The predefined operation rule or the AI model is characterized by being made through training. Here, the predefined operation rule or the AI being made through the training means the predefined operation rule or the AI model configured to perform the desired characteristics (or purpose) by allowing a basic AI model to use and learn pieces of training data by a learning algorithm. Such training may be made in the device itself in which the AI according to the present disclosure is performed, or may be made through a separate server and/or system. Examples of the learning algorithms include supervised learning, unsupervised learning, semi-supervised learning, or reinforcement learning, but are not limited to the above examples.

The AI model may be created through training. The AI model may include a plurality of neural network layers. Each of the plurality of neural network layers has a plurality of weight values, and performs a neural network operation through an operation between a calculation result of a previous layer and a plurality of weight values. The plurality of weight values of the plurality of neural network layers may be optimized by the training results of the AI model. For example, the plurality of weight values may be updated to reduce or minimize a loss value or a cost value acquired in the AI model during the learning process.

The AI network may a include deep neural network (DNN), and examples of the artificial neural network may include a convolutional neural network (CNN), a DNN, a recurrent neural network (RNN), a restricted Boltzmann machine (RBM), a deep belief network (DBN), a bidirectional recurrent deep neural network (BRDNN), a deep Q-Network, and the like, but is not limited to the above examples.

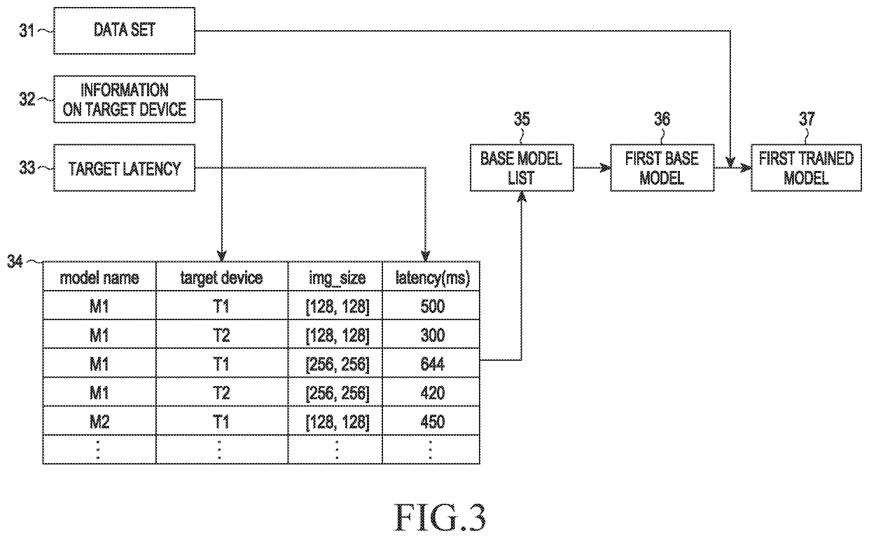

FIG. 3 is a diagram for describing a method of performing the first project according to an embodiment of the present disclosure.

Referring to FIG. 3, the electronic apparatus 100 may receive a data set 31, information 32 on a target device, and target latency 33 configured by a user. For example, the information 32 on the target device may indicate a first device Ti. The target latency 33 may be 500 ms.

The electronic apparatus 100 may compare the information 32 on the target device and the target latency 33 with a look-up table 34. The look-up table 34 may include a model name, a name of the target device, a resolution of an image input to the model, and latency when the model is executed on the target device. The electronic apparatus 100 refers to the look-up table 34 to identify a model that corresponds to the information 32 on the target device and has a difference from the target latency 33 within a preset range (e.g., 100 ms). For example, the electronic apparatus 100 may identify a first model M1 and a second model M2 corresponding to the first device Ti.

The electronic apparatus 100 may provide a user with a base model list 35 including information on the first model M1 and the second model M2. For example, the base model list 35 may be displayed on a user device. The user may select a first base model 36 from a plurality of base models included in the base model list 35. The electronic apparatus 100 may derive a first trained model 37 based on the data set 31 and the first base model 36.

Meanwhile, FIG. 3 illustrates that the latency for each combination of three pieces of information (i.e., the model name, the name of the target device, and the resolution of the image input to the model) is recorded in the look-up table 34. However, this is only an example, and the latency for a combination of additional information may be recorded in the look-up table 34. For example, the latency may be recorded for each combination of a batch size, a framework, and a data type of model in addition to the three pieces of information.

In FIG. 3, a method of acquiring a base model list 35 based on the target latency 33 has been described. However, the present disclosure is not limited thereto, and the electronic apparatus 100 may acquire the base model list 35 based on various types of performance indicators. For example, the electronic apparatus 100 may acquire the base model list 35 based on accuracy, power consumption, and/or memory usage.

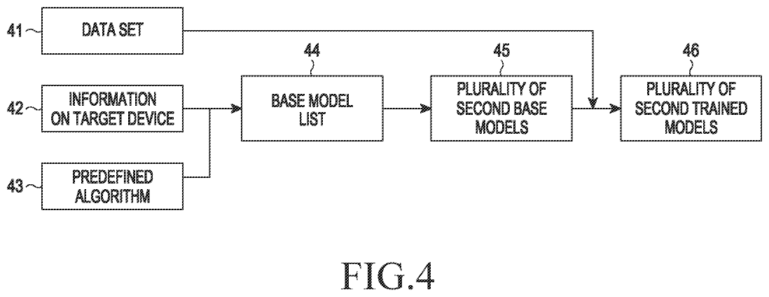

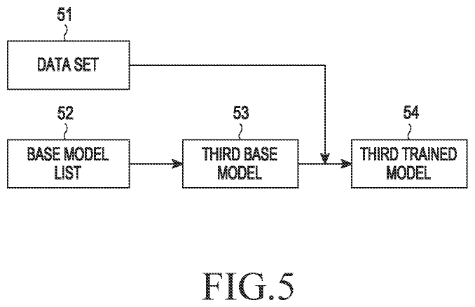

FIG. 4 is a diagram for describing a method of performing the second project according to an embodiment of the present disclosure.

Referring to FIG. 4, the electronic apparatus 100 may acquire a data set 41, information 42 on a target device, and a predefined algorithm 43. The electronic apparatus 100 may acquire a base model list 44 including information on a plurality of base models based on the information 42 on the target device and the predefined algorithm 43. The predefined algorithm 43 may include a hyperparameter optimization algorithm and a neural network architecture search algorithm.

The electronic apparatus 100 may provide the base model list 44 to a user. For example, the base model list 44 may be displayed on a user device. The user may select a plurality of second base models 45 from the base model list 44. The electronic apparatus 100 may derive a plurality of second trained models 46 based on the data set 41 and the plurality of second base models 45.

Meanwhile, the electronic apparatus 100 may derive a plurality of second trained models 46 without a user input for selecting the plurality of second base models 45. For example, the electronic apparatus 100 may derive base models of a predetermined number and derive trained models corresponding to the derived base models. Alternatively, the electronic apparatus 100 may identify the plurality of second base models 45 of which performances are within a predetermined performance range from the plurality of base model lists 44. For example, the electronic apparatus 100 may identify the plurality of second base models 45 within a predetermined accuracy range and a predetermined latency range from the plurality of base model lists 44. Here, the predetermined number and the predetermined performance range may be configured by a user. For example, the user may input the predetermined performance range to the user device as the target performance.

FIG. 5 is a diagram for describing a method of performing the third project according to an embodiment of the present disclosure.

Referring to FIG. 5, the electronic apparatus 100 may receive a data set 51. The data set 51 may be the data set 31 used in the first project or the data set 41 used in the second project. Alternatively, the data set 51 may be a new data set not used in the first project or the second project. The data set 51 may be stored in a data set DB. The data set DB may be included in the memory 120 of the electronic apparatus 100.

The electronic apparatus 100 may acquire a base model list 52. The base model list 52 may include neural network models acquired in a previous project. That is, the base model in the third project may be one of the trained models acquired in the previous project. For example, the base model list 52 may include a first trained model 37 acquired in the first project and a plurality of second trained models 46 acquired in the second project. The electronic apparatus 100 may acquire the base model list 52. The user may select the third base model 53 from the base model list 52. The electronic apparatus 100 may acquire a third trained model 54 based on the data set 51 and the third base model 53.

Meanwhile, the electronic apparatus 100 may acquire the data set 51 from the data set DB without user selection. In this case, the electronic apparatus 100 may transmit a command to an external device so that the acquired data set 51 is recommended to a user. Accordingly, the external device may recommend the data set 51 acquired by the electronic apparatus 100 to the user. Alternatively, the electronic apparatus 100 may acquire the third trained model 54 based on the data set 51.

The electronic apparatus 100 may acquire the third trained model 54 based on a compressed model. Here, the compressed model may mean a lightweight model generated by compressing the trained model acquired through the first project, the second project, or the third project.

The electronic apparatus 100 may acquire the data set 51 from the data set DB based on whether the third base model 53 is a compressed model. When the third base model 53 is the compressed model, the electronic apparatus 100 may acquire the data set used to train the third base model 53 as the data set 51. For example, when the third base model 53 is the first trained model 37, the electronic apparatus 100 may acquire the data set 31. When the third base model 53 is the compressed model, the accuracy of the model may decrease while the compression is in progress. The electronic apparatus 100 may acquire the third trained model 54 having improved accuracy compared to the third base model 53 by performing the third project.

When the third base model 53 is not the compressed model, the electronic apparatus 100 may acquire the data set not used to train the third base model 53 as the data set 51. For example, when the third base model 53 is the first trained model 37, the electronic apparatus 100 may acquire a data set other than the data set 31. Therefore, the third trained model 54 may accurately infer not only the data set 31 but also the new data set.

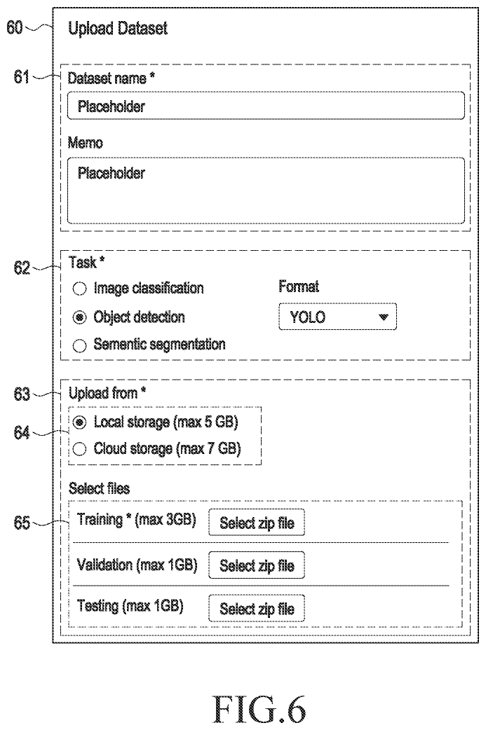

FIGS. 6 to 9 are various screens provided to a user. Each screen may be displayed on a user device.

FIG. 6 is a data set input screen according to an embodiment of the present disclosure.

Referring to FIG. 6, a data set input screen 60 is a screen for receiving a data set input from a user. The data set input screen 60 may include a first region 61 for receiving a name of a data set and a user memo. The data set input screen 60 may include a second region 62 for receiving a task to be performed by a trained model through a data set. The task may include image classification, object detection, and semantic segmentation. The second region 62 may receive a format of a data set. The format of the data set may include formats of You only look once (YOLO), visual object classes (VOC), and common objects in context (COCO). A user interface (UI) element for a user to input a task or a format of a data set may be displayed in the second region 62.

The data set input screen 60 may include a third region 63 for receiving an upload path of a data set and a file of the data set. The upload path of the data set may include local storage and cloud storage. A UI element 64 for a user to select an upload path of a data set may be displayed in the third region 63. A UI element 65 for a user to select a file of a data set may be displayed in the third region 63. When the local storage is selected in the UI element 64, the UI element 65 may receive a file. When the cloud storage is selected in the UI element 64, the UI element 65 may receive a link.

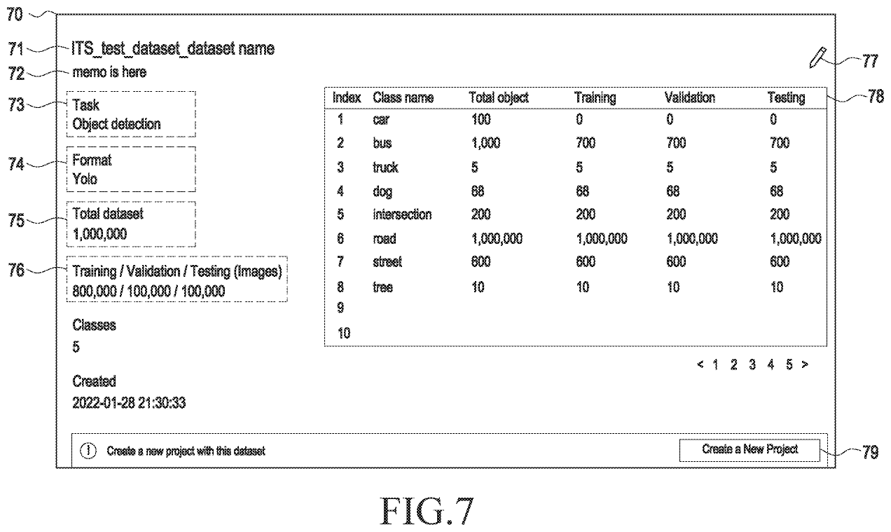

FIG. 7 is a diagram illustrating a data set confirmation screen according to an embodiment of the present disclosure.

Referring to FIG. 7, a data set confirmation screen 70 is a screen that displays detailed information on a data set input by a user. Information input by a user on the data set input screen 60 may be displayed on the data set confirmation screen 70. For example, a name of a data set 71, a user memo 72, a task 73 to be performed by the model to be trained through the data set, a format 74 of the data set, the total number 75 of data sets, and the number 76 for each type of data set may be displayed on the data set confirmation screen 70.

A button 77 for modifying a data set, a table 78 representing a data set, and a button 79 for creating a project using the data set may be displayed on the data set confirmation screen 70. When a user presses the button 79, a user device may transmit a project creation command to the electronic apparatus 100. When the project creation command is received, the electronic apparatus 100 may configure a project based on the data set.

Although not illustrated, information on a project related to a data set may be displayed on the data set confirmation screen 70. For example, the project related to the data set may include a project acquired using the data set. The information on the project may include a task of a trained model acquired through the project, information on a data set used in the project, information on a target device corresponding to the project, and a purpose of the project.

When the input of the data configured by the user is completed, the data set may be uploaded to the electronic apparatus 100. The user device may transmit the input data set and information (e.g., the name of the data set, etc.) related to the data set to the electronic apparatus 100. The electronic apparatus 100 may store a data set and information related to the data set in a data set DB included in the memory 120.

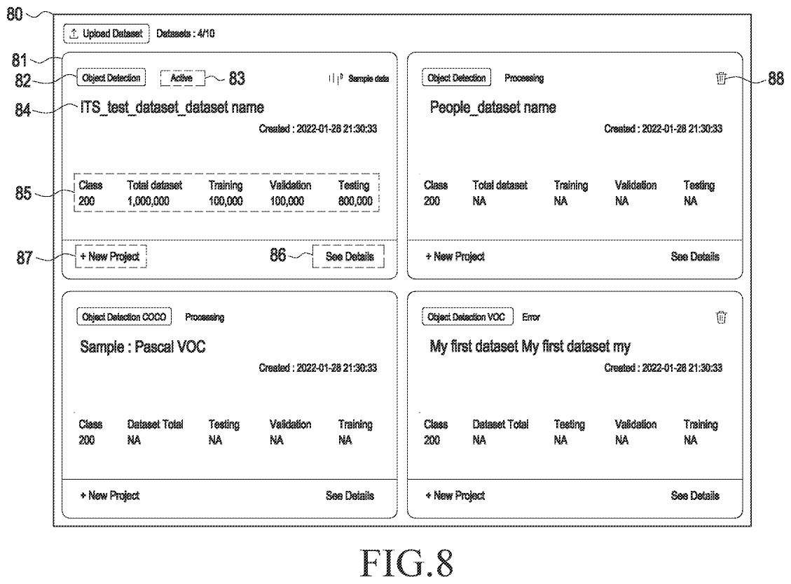

FIG. 8 is a data set list screen according to an embodiment of the present disclosure.

Referring to FIG. 8, a data set list screen 80 is a screen for displaying a data set list. The user may confirm the uploaded data set on the data set list screen 80, create the project based on the data set, and delete the data set. The data set list may be stored in the data set DB included in the memory 120.

A plurality of data sets stored in the data set DB and information related to each of the plurality of data sets may be displayed on the data set list screen 80. For example, information 81 related to the first set of data may be displayed on the data set list screen 80. The task 82 of the model to be trained using the first set of data and the upload state 83 of the first set of data included in the information 81 related to the first set of data may be displayed. An upload completion state, an uploading state, and an error occurrence state included in the upload state 83 may be displayed.

The name 84 of the first set of data and the number 85 of data sets may be displayed on the data set list screen 80. A button 86 for displaying detailed information on the first set of data may be displayed on the data set list screen 80. For example, when the button 86 is input, the data set confirmation screen 70 corresponding to the first set of data may be displayed on the data set list screen 80. A button 87 for configuring a project using a data set may be displayed on the data set list screen 80. A button 88 for deleting the uploaded data set may be displayed on the data set list screen 80.

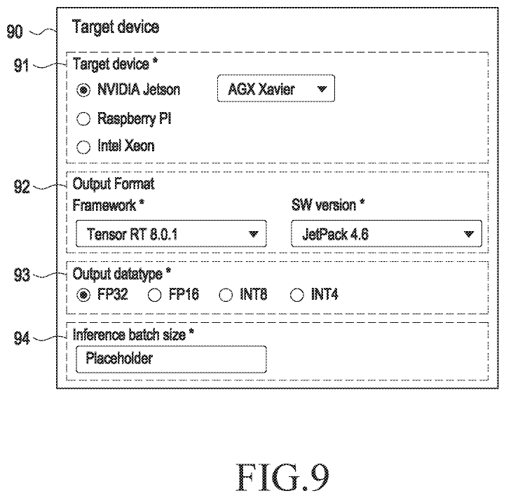

FIG. 9 is a target device input screen according to an embodiment of the present disclosure.

Referring to FIG. 9, a target device input screen 90 is a screen for receiving information related to a target device from a user. The target device input screen 90 may include a first region 91 for receiving a name and version of the target device. A UI element for a user to select the name and version of the target device may be displayed in the first region 91.

The target device input screen 90 may include a second region 92 for receiving an output format for acquiring a neural network model corresponding to the target device. The output format may include a framework and a software version. UI elements for a user to select each of the framework and the software version may be displayed in the second region 92.

The target device input screen 90 may include a third region 93 for receiving a type of output data for acquiring a neural network model corresponding to the target device. UI elements for a user to select a type of output data may be displayed in the third region 93. Some of the UI elements displayed in the second region 92 and/or the third region 93 may be deactivated according to items selected in the first region 91. The target device input screen 90 may include a fourth region 94 for receiving a size of an inference batch for acquiring a neural network model corresponding to the target device.

Although not illustrated, a training mode selection screen for receiving the training mode 13 may be displayed on the user device. The training mode selection screen may include UI elements (e.g., button) each corresponding to one of a plurality of training modes. When the user selects the training mode, the user device may transmit a command related to the selected training mode to the electronic apparatus 100. The electronic apparatus 100 may configure a project based on the selected training mode.

Also, a learning resource selection screen for receiving a selection of a learning resource from a user may be displayed on the user device. The learning resource may generate a trained model by training the base model. For example, the learning resource may include an external server. A UI element corresponding to at least one learning resource may be displayed on the learning resource selection screen. When the user selects the UI element, the user device may transmit a command related to the learning resource corresponding to the selected UI element. The electronic apparatus 100 may transmit the base model as the learning resource. The electronic apparatus 100 may receive the trained model generated by the learning resource from the learning resource.

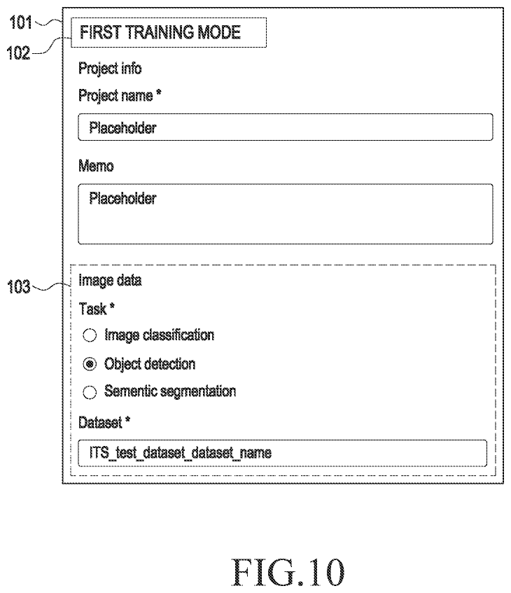

FIG. 10 is a project information screen according to an embodiment of the present disclosure.

Referring to FIG. 10, a project information screen 101 may display information on a project configured based on information input by a user. For example, a training mode 102 selected by a user and information 103 on a data set input by the user may be displayed on the project information screen 101. The information 103 on the data set may include a task to be performed by a trained model to be acquired through a project and identification information of the data set.

Although not illustrated, the project information screen 101 may include a learning configuring region for receiving learning configuring information. The learning configuring information may include target performance of the trained model, a size of input data of the trained model (e.g., resolution of an input image), a training epoch, and data augmentation.

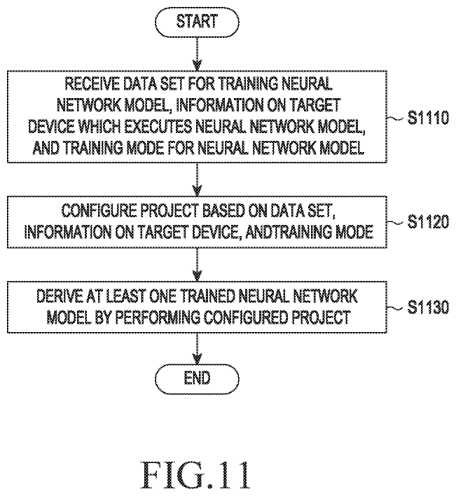

FIG. 11 is a diagram for describing a method of controlling an electronic apparatus according to an embodiment of the present disclosure.

Referring to FIG. 11, an electronic apparatus 100 may receive a data set for training a neural network model, information on a target device to execute the neural network model, and a training mode for the neural network model (S1110). The electronic apparatus 100 may receive a data set for training a neural network model, information on a target device to execute the neural network model, and a training mode for the neural network model from a user device.

The electronic apparatus 100 may configure a project based on the data set, the information on the target device, and the training mode (S1120). The electronic apparatus 100 may configure a project based on the data set, the information on the target device, and the training mode. The project may be classified according to the training mode. For example, a project configured by the first training mode may be classified as a first project, the project configured by the second training mode may be classified as a second project, and the project configured by the third training mode may be classified as a third project.

The electronic apparatus 100 may derive at least one trained neural network model by performing the project (S1130). The derived model may be a model optimized for the target device. Hereinafter, a method of performing a project will be described in more detail.

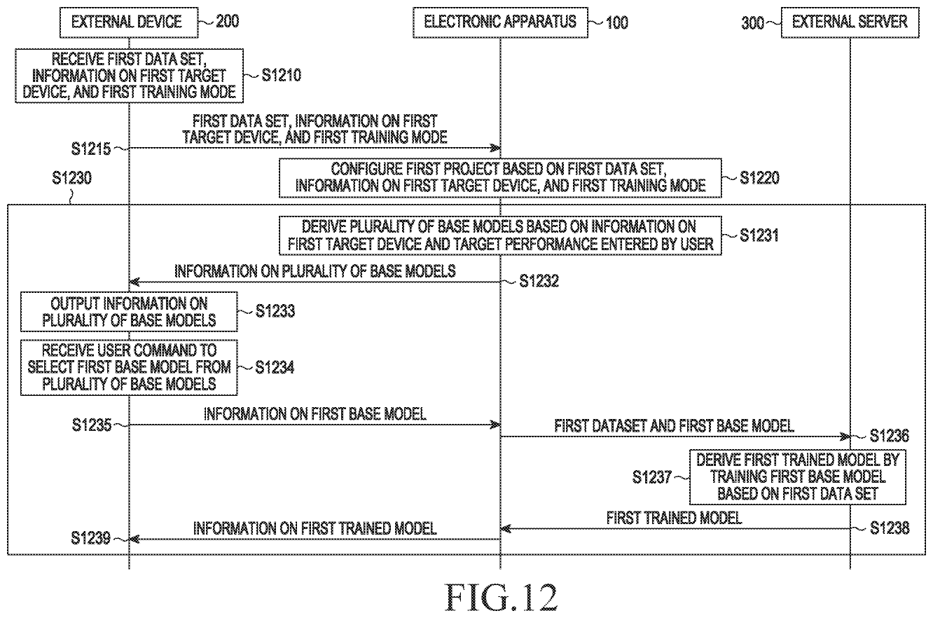

FIG. 12 is a sequence diagram illustrating a method of performing the first project according to an embodiment of the present disclosure.

Referring to FIG. 12, a system 1000 for providing a neural network model may include the electronic apparatus 100, an external device 200, and an external server 300. The external device 200 may be a user device that interacts with a user. The external server 300 may be a learning server that generates a trained model based on a data set.

The external device 200 may receive a first set of data, information on a first target device, and a first training mode (S1210). The external device 200 may transmit the first set of data, the information on the first target device, and the first training mode to the electronic apparatus 100 (S1215). In the present disclosure, the operation of transmitting the training mode means an operation of transmitting information indicating the training mode.

The electronic apparatus 100 may configure the first project based on the first set of data, the information on the first target device, and the first training mode (S1220). The electronic apparatus 100 may perform the configured first project (S1230). Hereinafter, the operation of performing the first project (S1230) will be described in more detail.

The electronic apparatus 100 may derive a plurality of base models based on the information on the first target device and target performance input by the user (S1231). For example, the electronic apparatus 100 may store a plurality of neural network models and a look-up table including information on each of the plurality of neural network models. The electronic apparatus 100 may identify, as a base model, a neural network model, which corresponds to a target device and has a difference in performance from the target performance within a preset range, among a plurality of neural network models using the look-up table.

The electronic apparatus 100 may transmit information on a plurality of base models to the external device 200 (S1232). In this case, the electronic apparatus 100 may transmit a command for displaying information on a plurality of base models to the external device 200.

The external device 200 may output information on a plurality of base models (S1233). For example, the external device 200 may display information on each of the plurality of base models. To this end, the external device 200 may include various output units including a display and a speaker.

The external device 200 may receive a user command for selecting a first base model from a plurality of base models (S1234). The external device 200 may transmit the information on the first base model to the electronic apparatus 100 (S1235).

The electronic apparatus 100 may transmit the first set of data and the first base model to the external server 300 (S1236). The external server 300 may be selected by the user. For example, the external device 200 may display a plurality of external servers and receive a user input for selecting one of the plurality of external servers. The operation of selecting the external server 300 by the user may be performed before the operation of performing the first project (S1230) or during the operation of performing the first project (S1230).

The external server 300 may derive the first trained model by training the first base model based on the first set of data (S1237). The external server 300 may transmit the first trained model to the electronic apparatus 100 (S1238). Meanwhile, in another embodiment, the first trained model may be generated by the electronic apparatus 100. That is, the electronic apparatus 100 may perform the function of the external server 300. In this case, operations S1237 and S1238 may be omitted.

The electronic apparatus 100 may transmit the information on the first trained model to the external device 200 (S1239). The external device 200 may provide the information on the first trained model to the user. For example, the information on the first trained model may include the performance information of the first trained model, a download file of the first trained model, and a download link.

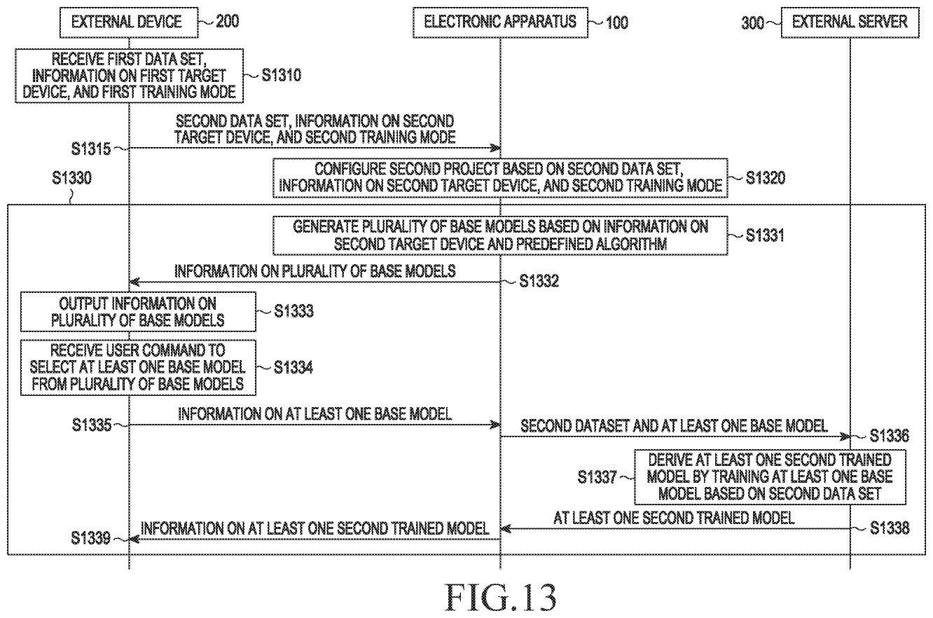

FIG. 13 is a sequence diagram illustrating a method of performing the second project according to an embodiment of the present disclosure.

Referring to FIG. 13, the external device 200 may receive the second set of data, the information on the second target device, and the second training mode (S1310), and transmit the acquired second set of data, information on the second target device, and second training mode to the electronic apparatus 100 (S1315). The electronic apparatus 100 may configure the second project based on the second set of data, the information on the second target device, and the second training mode (S1320). The electronic apparatus 100 may perform the second project (S1330). Hereinafter, the operation of performing the second project (S1330) will be described in more detail.

The electronic apparatus 100 may generate a plurality of base models based on the information on the second target device and the predetermined algorithm (S1331). The predefined algorithm may include at least one of a hyperparameter optimization algorithm or a neural network architecture search algorithm. The hyperparameter optimization algorithm may include hyper-parameter optimization (HPO). The HPO may be an algorithm for finding an optimal hyperparameter in a given hyperparameter search space. For example, the HPO can create several base models by changing some layers of a neural network model, and search for base models with good performance while evaluating the performance of each base model. The HPO may utilize algorithms such as hyperband and Bayesian optimization.

The electronic apparatus 100 may transmit information on a plurality of base models to the external device 200 (S1332). The external device 200 may output information on a plurality of base models (S1333). The external device 200 may receive a user command for selecting at least one base model from a plurality of base models (1334). For example, the external device 200 may acquire a user command for selecting a plurality of base models. The external device 200 may transmit the information on at least one base model to the electronic apparatus 100 (S1335). The electronic apparatus 200 may transmit the second set of data and at least one base model to the external server 300 (S1336).

The external server 300 may derive at least one second trained model by training at least one base model based on the second set of data (S1337). The external server 300 may transmit at least one second trained model to the electronic apparatus 100 (S1338). The electronic apparatus 100 may transmit the information on at least one second trained model to the external device 200.

Meanwhile, in another embodiment, the electronic apparatus 100 may acquire at least one second trained model without a user command for selecting a base model. For example, the electronic apparatus 100 may generate a plurality of base models, and acquire a plurality of second trained models in which each of the plurality of base models are trained. That is, the electronic apparatus 100 may transmit the second set of data and the plurality of base models to the external server 300, and may receive the plurality of second trained models from the external server 300. In this case, operations S1332, S1333, S1334, and S1335 may be omitted.

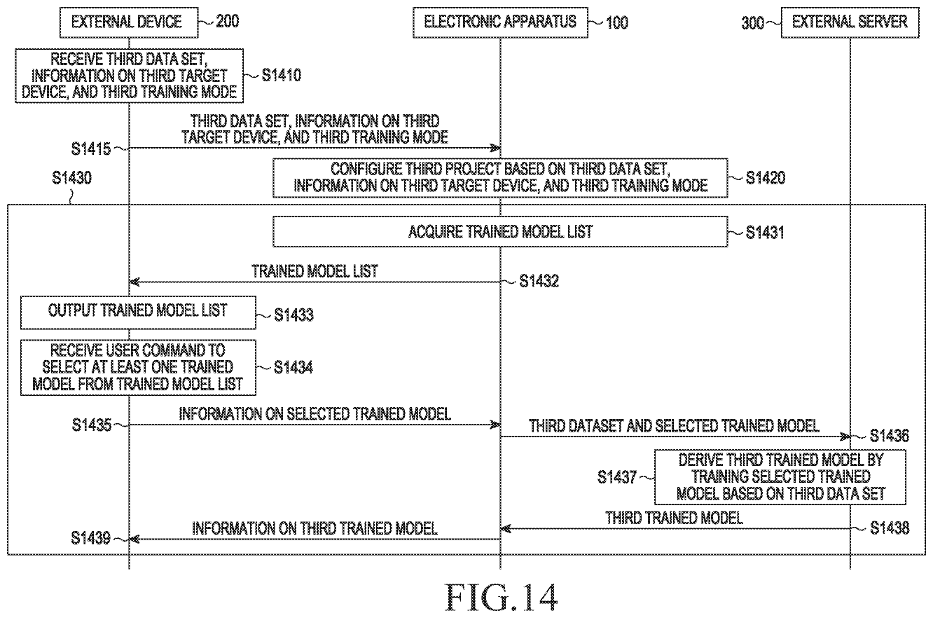

FIG. 14 is a sequence diagram illustrating a method of performing the third project according to an embodiment of the present disclosure.

Referring to FIG. 14, the external device 200 may receive the third set of data, the information on the third target device, and the third training mode (S1410), and transmit the acquired third set of data, information on the third target device, and third training mode to the electronic apparatus 100 (S1415). The electronic apparatus 100 may configure the third project based on the third set of data, the information on the third target device, and the third training mode (S1420). In another embodiment, the operation of acquiring the information on the third target device and transmitting the acquired information to the electronic apparatus 100 may be omitted. For example, when the third training mode is selected by the user, the electronic apparatus 100 may acquire the information on the target device corresponding to the project performed before the third project from the project DB. For example, when the electronic apparatus 100 performs the third project after performing the first project, the electronic apparatus 100 may acquire the information on the first target device used in the first project.

The electronic apparatus 100 may configure the third project based on the third set of data, the information on the third target device, and the third training mode (S1420). The electronic apparatus 100 may perform the third project (S1430). Hereinafter, the operation of performing the third project (S1430) will be described in more detail.

The electronic apparatus 100 may acquire the trained model list (S1431). For example, the electronic apparatus 100 may acquire the trained model list from the model DB. The trained model list may include information on a plurality of trained models stored in the model DB.

The electronic apparatus 100 may transmit the trained model list to the external device 200 (S1432). The external device 200 may output the trained model list (1433). In another embodiment, operations S1431 and S1432 may be omitted. For example, the trained model list may be stored in the external device 200.

The external device 200 may receive a user command for selecting one trained model from the trained model list (S1434). The external device 200 may transmit the information on the selected trained model to the electronic apparatus 100 (S1435). The electronic apparatus 100 may transmit the third set of data and the selected trained model to the external server 300 (S1436). The external server 300 may derive the third trained model by training the selected trained model based on the third set of data (S1437). That is, in the third project, the base model may be a trained model generated through the first project or the second project. In addition, the base model of the third project may include a retrained model (i.e., a model acquired through another third project) based on the trained model generated through the first project or the second project.

The external server 300 may transmit the third trained model (S1438). The electronic apparatus 100 may transmit the information on the third trained model to the external device 200 (S1439).

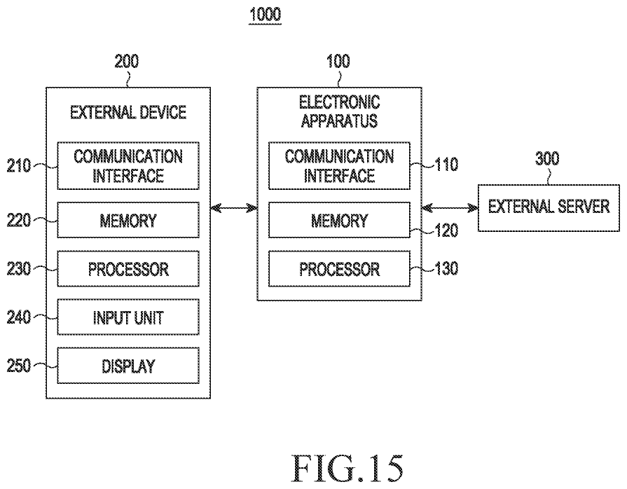

FIG. 15 is a block diagram illustrating a configuration of a system for providing a neural network model according to an embodiment of the present disclosure.

Referring to FIG. 15, the system 1000 for providing a neural network model may include the electronic apparatus 100, the external device 200, and the external server 300. The electronic apparatus 100 may acquire information on a neural network model based on a user input acquired through the external device 200 via a communications and/or data network. The electronic apparatus 100 may transmit information on a neural network model to the external device 200 via the network. The external device 200 may provide a user with the information on the neural network model received from the electronic apparatus 100 via the network.

The memory 120 may store information on a plurality of neural network models. The information on the plurality of neural network models may include identification information of the plurality of neural network models, information on a plurality of devices in which the plurality of neural network models are executed, performance information of the plurality of neural network models when the plurality of neural network models are executed in a plurality of devices, and the size of the input data of the plurality of neural network models. Each piece of information may be matched with each other and stored in the form of a look-up table.

The processor 130 may acquire the information on the target device which executes the neural network model and the target performance of the neural network model when the neural network model is executed in the target device. The target performance may include at least one of target accuracy, a target delay time, or a target amount of computation. The processor 130 may receive the information on the target device and the target performance of the neural network model from the external device through the communication interface 110. The external device 200 may acquire a user command for inputting the information on the target device and the target performance of the neural network model through an input unit 240.

The processor 130 may acquire information on a plurality of candidate neural network models based on the information on the target device and the target performance. The information on the plurality of candidate neural network models may include at least one of names of a plurality of candidate neural network models, performance of the plurality of candidate neural network models, or sizes of input data of the plurality of candidate neural network models.

The processor 130 may acquire the information on the plurality of candidate neural network models from the memory 120. The processor 130 may identify the plurality of candidate neural network models from among the plurality of neural network models by comparing the information on the target device and the target performance and the information on the plurality of neural network models stored in the memory 120. The processor 130 may acquire the information on the plurality of identified candidate neural network models from the memory 120.

The processor 130 may identify, as a plurality of candidate neural network models, neural network models of which each ranking based on a difference in performance from the target performance among the plurality of neural network models stored in the memory 120 is a preset ranking or higher. The preset ranking may be fifth. A neural network model with a small difference in performance from the target performance may have a higher ranking. For example, the plurality of neural network models may include first to tenth neural network models. Among them, each of the first to fifth neural network models may be ranked first to fifth. In this case, the processor 130 may identify the first to fifth neural network models as a plurality of candidate neural network models.

The processor 130 may identify neural network models having a difference from target performance within a preset range among the plurality of neural network models as a plurality of candidate neural network models. For example, the target performance is a target latency, and the preset range may be 100 ms.

The processor 130 may control the communication interface 110 to transmit a command to the external device 200 to display information on a plurality of candidate neural network models based on the target performance. The external device 200 may display information on a plurality of candidate neural network models based on the transmitted command. Unless otherwise specified in the present disclosure, the fact that the processor 130 transmits a command to the external device 200 means that the processor 130 controls the communication interface 110 to transmit a command to the external device 200. Meanwhile, when the electronic apparatus 100 transmits a display command to the external device 200, it is obvious that the external device 200 displays information corresponding to the display command unless specially specified.

The processor 130 may transmit a command to the external device 200 to display a plurality of UI elements representing information on a plurality of candidate neural network models, respectively, in a reverse order of difference between the performance of the corresponding candidate neural network model and the target performance. Each of the plurality of UI elements may display information on one of a plurality of candidate neural network models when a cursor is placed on each of the plurality of UI elements.

The plurality of candidate neural network models may include a plurality of first candidate neural network models of a first type and a plurality of second candidate neural network models of a second type. The first candidate neural network model may be a model acquired based on project information configured by a user. The project information may include various types of information (e.g., a size of input data of a neural network model generated through the project) defining a project. For example, the first candidate neural network model may be a model having the same size of input data as that of input data configured by a user. The second candidate neural network model may be a model acquired based on partially modified project information from project information configured by a user. For example, the second candidate neural network model may have a size of input data different from the size of input data configured by the user, and may have performance within a preset range from the target performance configured by the user.

A plurality of UI elements may include a plurality of first UI elements each corresponding to one of a plurality of first candidate neural network models, and a plurality of second UI elements each corresponding to one of a plurality of second candidate neural network models. The processor 130 may transmit a command to the external device 200 to simultaneously display the plurality of first UI elements and the plurality of second UI elements in different regions. Accordingly, the external device 200 may simultaneously display the plurality of first UI elements and the plurality of second UI elements in different regions.

The processor 130 may transmit a command to the external device 200 to display a plurality of UI elements each indicating the information on one of the plurality of candidate neural network models on a two-dimensional graph. The two-dimensional graph may be defined by a first axis corresponding to the first performance parameter and a second axis corresponding to the second performance parameter. For example, the first performance parameter may be a latency-related parameter, and the second performance parameter may be an accuracy-related parameter.

The plurality of UI elements include third UI elements, in which the performance of the candidate neural network model, each corresponding to one of the plurality of UI elements corresponds to the target performance, and fourth UI elements in which the performance of the corresponding candidate neural network model does not correspond to the target performance. The processor 130 may transmit a command to the external device 200 to activate the third UI elements and deactivate the fourth UI elements.

The external device 200 may be implemented as a personal computer (PC). The external device 200 may include a communication interface 210, a memory 220, a processor 230, an input unit 240, and a display 250.

The processor 230 may control the communication interface 210 to transmit a user command acquired through the input unit 240 to the electronic apparatus 100. For example, the processor 230 may control the communication interface 210 to transmit a user command for selecting one of a plurality of candidate neural network models to the electronic apparatus 100.

The input unit 240 is configured to receive various user commands in relation to the operation of the external device 200. The input unit 240 may be implemented as an input/output interface that receives various input signals from an external input means such as a keyboard or a mouse connected to the external device 200. Alternatively, the input unit 240 may be implemented as a touch screen on the display 250.

The display 250 may display various types of information according to the control of the processor 230. For example, the display 250 may display information on a plurality of candidate neural network models.

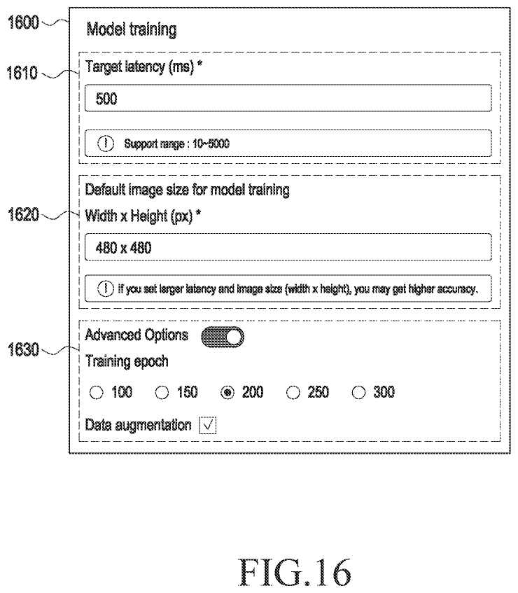

FIG. 16 is a diagram illustrating a learning setting screen according to an embodiment of the present disclosure.

Referring to FIG. 16, a learning setting screen 1600 is a screen for receiving learning setting information from a user and may be displayed on the external device 200. The learning setting information may include a size of input data (e.g., resolution of an input image), a training epoch, and data augmentation of the trained model.

The learning setting screen 1600 may include a first region 1610 for receiving a target performance (e.g., latency). The first region 1610 may receive a single value or a range value (e.g., 400 to 500). The learning setting screen 1600 may include a second region 1620 for receiving the size of input data of a neural network model, and a third region 1630 for receiving whether to perform the data augmentation and a training epoch.

When a user input for each region 1610, 1620, and 1630 is acquired, the external device 200 may transmit information related to the user input to the electronic apparatus 100. The electronic apparatus 100 may acquire a plurality of candidate neural network models based on the target performance input by the user and the size of the input data and transmit the acquired neural network models to the external device 200.

Meanwhile, the size of the data set input by the user may be different from the size of the set input data. For example, the data set input by the user may be an image set of a first resolution, and the size of the set input data may be a second resolution different from the first resolution. In this case, the electronic apparatus 100 may convert the size of the data set input by the user into the size of the set input data. For example, the electronic apparatus 100 may acquire the image set of the second resolution from the image set of the first resolution.

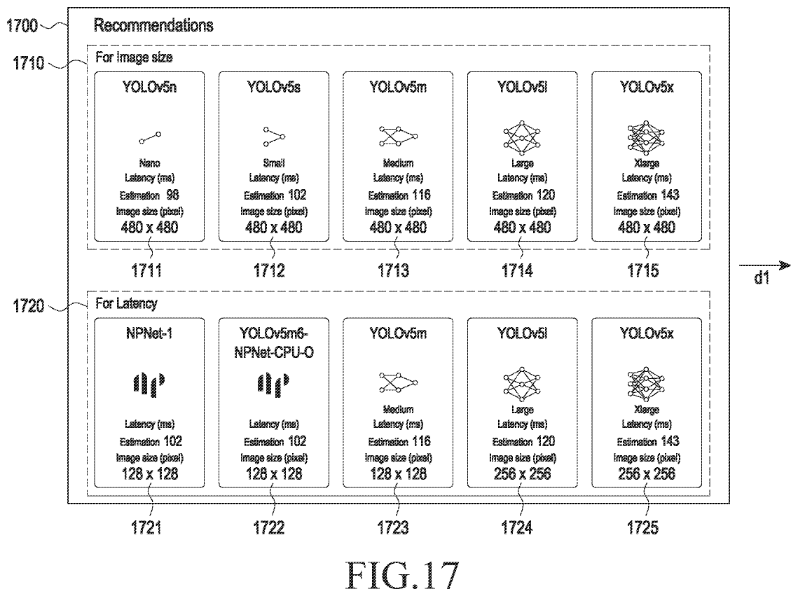

FIG. 17 is a base model recommendation screen according to an embodiment of the present disclosure.

Referring to FIG. 17, a base model recommendation screen 1700 is a screen for recommending a plurality of candidate neural network models to a user and may be displayed on the external device 200. The user may select a base model from a plurality of candidate neural network models. The system 1000 for providing a neural network model may generate a trained model based on the base model selected by the user and provide the generated trained model to the user.

A plurality of UI elements 1711, 1712, 1713, 1714, 1715, 1721, 1722, 1723, 1724, and 1725 each representing information on one of a plurality of candidate neural network models may be displayed on the base model recommendation screen 1700. Each UI element may represent information on a corresponding candidate neural network model. For example, the information on the candidate neural network model may include the name, size, latency, and size of input data of the candidate neural network model.

The plurality of UI elements 1711, 1712, 1713, 1714, 1715, 1721, 1722, 1723, 1724, and 1725 may be displayed based on the target performance input by the user and the size of input data of the neural network model. For example, the target latency may be 100 ms, and the size of the input data may be 480×480 px.

The plurality of UI elements 1711, 1712, 1713, 1714, 1715, 1721, 1722, 1723, 1724, and 1725 may be displayed in a reverse order of a difference between the corresponding latency and the target latency. For example, the latency corresponding to the first UI elements 1711, 1712, 1713, 1714, and 1715 may be 98 ms, 102 ms, 116 ms, 120 ms, and 143 ms, respectively. The first UI elements 1711, 1712, 1713, 1714, and 1715 may be sequentially displayed in a first direction dl. Similarly, the second UI elements 1721, 1722, 1723, 1724, and 1725 may be sequentially displayed in the first direction dl.

Meanwhile, the plurality of UI elements 1711, 1712, 1713, 1714, 1715, 1721, 1722, 1723, 1724, and 1725 may be divided into the first UI elements 1711, 1712, 1713, 1714, and 1715 whose corresponding latencies are the same as the size of input data configured by the user and the second UI elements 1721, 1722, 1723, 1724, and 1725 whose corresponding latencies are different from the size of input data configured by the user. The first UI elements 1711, 1712, 1713, 1714, and 1715 and the second UI elements 1721, 1722, 1723, 1724, and 1725 may be displayed in different regions. For example, the first UI elements 1711, 1712, 1713, 1714, and 1715 may be displayed in the first region 1710, and the second UI elements 1721, 1722, 1723, 1724, and 1725 may be displayed on the second region 1720. The first UI elements 1711, 1712, 1713, 1714, and 1715 and the second UI elements 1721, 1722, 1723, 1724, and 1725 may be simultaneously displayed. The first region 1710 and the second region 1720 may be positioned in a direction perpendicular to the first direction dl.

In FIG. 17, the first UI elements 1711, 1712, 1713, 1714, and 1715 corresponding to the base model which is acquired based on the size of the input data are displayed in the first area 1710. And the second UI elements 1721, 1722, 1723, 1724, and 1725 corresponding to the base model which is acquired based on the latency are displayed in the second area 1720. However, this is an embodiment, and base models corresponding to UI elements to be displayed in each area may be selected based on various characteristics related to the neural network model. Also, UI elements having the same size of input data configured by the user may also be displayed in the second area 1720.

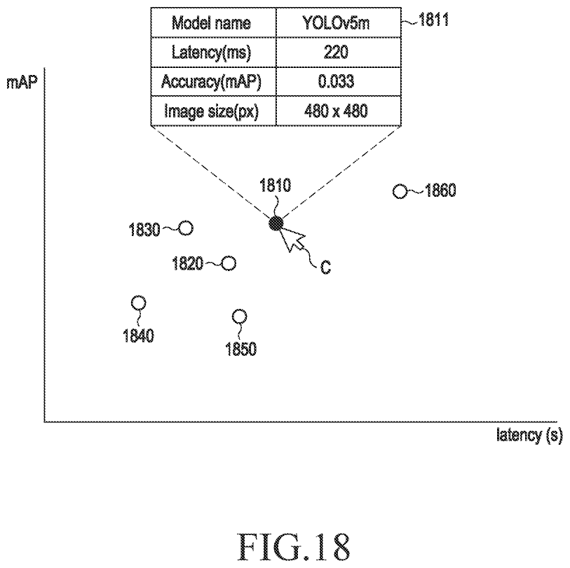

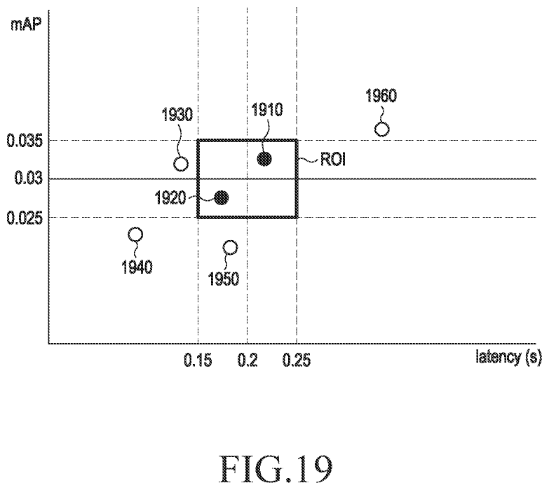

A method of displaying information about a candidate neural network model may vary according to a training mode. For example, the base model recommendation screen 1700 may indicate a method of displaying information on candidate neural network models in the first training mode. FIGS. 18 and 19 may indicate a method of displaying information about candidate neural network models in the second training mode.

FIG. 18 is a diagram for describing a method of displaying information on a neural network model according to an embodiment of the present disclosure.

Referring to FIG. 18, the external device 200 may display a plurality of UI elements 1810, 1820, 1830, 1840, 1850, and 1860 each corresponding to one of a plurality of neural network models. The external device 200 may display the plurality of UI elements 1810, 1820, 1830, 1840, 1850, and 1860 on a two-dimensional graph. The two-dimensional graph may be defined by a first axis corresponding to latency and a second axis corresponding to accuracy. The second axis may correspond to mean average precision (mAP).

When the UI element is selected by the user, the external device 200 may display information on a neural network model corresponding to the selected UI element. The user's selection may be made by placing a cursor C on the UI element or by an action (e.g., click) of selecting the UI element. For example, when the cursor C is placed on the first UI element 1810, the external device 200 may display information 1811 on a first neural network model corresponding to the first UI element 1810.

The plurality of neural network models may be base models. For example, the plurality of neural network models may be base models generated by allowing the electronic apparatus 200 to perform the second project. Alternatively, the plurality of neural network models may be base models acquired by allowing the electronic apparatus 200 to perform the first project.

The plurality of neural network models may be trained neural network models. For example, alternatively, the plurality of neural network models may be base models acquired by allowing the electronic apparatus 200 to perform the third project.

FIG. 19 is a diagram for describing a method of displaying information on a neural network model according to an embodiment of the present disclosure.

Referring to FIG. 19, the external device 200 may display UI elements 1910, 1920, 1930, 1940, 1950, and 1960 each corresponding to one of a plurality of neural network models based on a region of interest (ROI). The external device 200 may define the ROI based on the target performance configured by the user. The external device 200 may determine the ROI based on the target latency and target accuracy configured by the user.

The external device 200 may determine, as the ROI, a region defined by a time range preset from the target latency configured by the user and the accuracy range preset from the target accuracy configured by the user. For example, the target latency configured by the user may be 0.2 s, and the preset time range may be −0.05 s to +0.05 s. In addition, the target accuracy configured by the user may be 0.03, and the preset accuracy range may be −0.025 to 0.035. In this case, the external device 200 may define the ROI of FIG. 19.

Meanwhile, the target performance configured by the user may be a range value. In this case, the external device 200 may define the ROI without expanding the target performance configured by the user. For example, a user may set the target latency from 0.15 s to 0.25 s and the target accuracy from 0.025 to 0.035. In this case, the external device 200 may define the ROI of FIG. 19 by reflecting the target performance configured by the user as itis.

FIG. 19 illustrates that the ROI is defined by two axes, but this is only an example, and the ROI may be defined based on a single axis. For example, the ROI may be defined based on the target latency. The external device 200 may define a preset time range from the target latency as the ROI.

Among UI elements 1910, 1920, 1930, 1940, 1950, and 1960, the external device 200 may display UI elements 1910 and 1920 included in the ROI and UI elements 1930, 1940, 1950, and 1960 not included in the ROI to be distinguished. For example, the external device 200 may display visual characteristics (e.g., shape, color, etc.) of the UI elements 1910 and 1920 differently from those of the UI elements 1930, 1940, 1950, and 1960. Here, the UI elements 1910 and 1920 may correspond to candidate neural network models having performance within a preset range from the target performance of the neural network model. The UI elements 1930, 1940, 1950, and 1960 may correspond to candidate neural network models having performance outside a preset range from the target performance of the neural network model.

The external device 200 may activate the UI elements 1910 and 1920 included in the ROI. Accordingly, when at least one of the UI elements 1910 or 1920 is selected, the external device 200 may display information on a neural network model corresponding to the at least one selected UI element. For example, when the first UI element 1910 is selected, the external device 200 may display the information on the first neural network model corresponding to the first UI element 1910.

The external device 200 may deactivate UI elements 1930, 1940, 1950, and 1960 that are not included in the ROI. Accordingly, the UI elements 1930, 1940, 1950, and 1960 may become non-selectable.

Meanwhile, a method of displaying information about a neural network model may vary according to a training mode. For example, when the training mode is the first training mode, information on the neural network model may be displayed as shown in FIG. 17. When the training mode is the second learning mode, information on the neural network model may be displayed as shown in FIGS. 18 and 19.

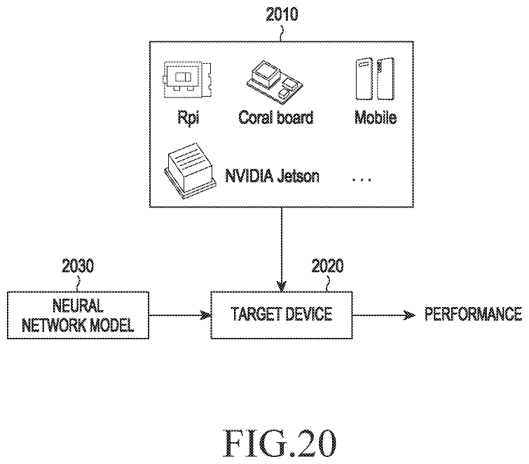

FIG. 20 is a diagram for describing a method of acquiring performance of a neural network model according to an embodiment of the present disclosure.

Referring to FIG. 20, the electronic apparatus 100 may acquire performance of a neural network model 2030 using a device farm 2010. The neural network model 2030 may be a base model or a trained model. The device farm 2010 may include information related to various devices. The electronic apparatus 100 may identify the target device 2020 in the device farm 2010 based on the information on the target device input by the user. The electronic apparatus 100 may measure the performance of the neural network model 2030 by executing the neural network model 2030 in the target device 2020. The device farm 2010 may be implemented as a DB included in the electronic apparatus 100.

The electronic apparatus 100 may generate a look-up table based on the performance of the neural network model 2030 acquired using the device farm 2010. As described above, the look-up table may include information on a plurality of neural network models including the performance of the plurality of neural network models.

The electronic apparatus 100 may compress the neural network model 2030 based on the performance of the neural network model 2030. For example, the electronic apparatus 100 may acquire a configuring value for compression of the neural network model 2030 based on the latency of the neural network model 2030.

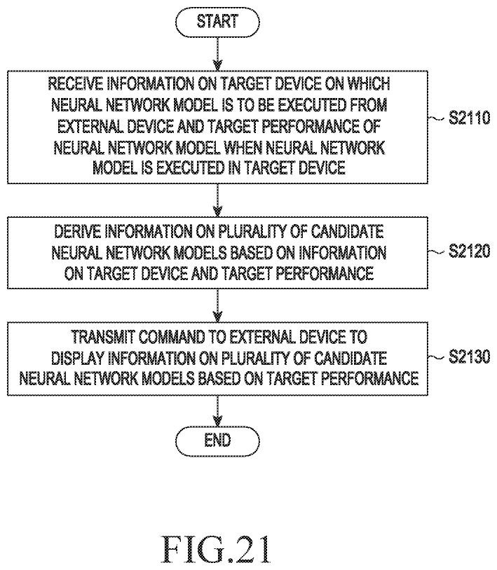

FIG. 21 is a diagram for describing a method of controlling an electronic apparatus according to an embodiment of the present disclosure.

Referring to FIG. 21, the electronic apparatus 100 may receive information on a target device on which the neural network model is to be executed from an external device and the target performance of the neural network model when the neural network model is executed in the target device (S2110). The target performance may include the target latency and target accuracy.

The electronic apparatus 100 may derive information on a plurality of candidate neural network models based on the information on the target device and the target performance (S2120). The candidate neural network model may be a base model or a trained model. For example, the electronic apparatus 100 may acquire a candidate neural network model by performing a project.

The electronic apparatus 100 may transmit a command to an external device to display information on a plurality of candidate neural network models based on the target performance (S2130). A method of displaying information on a plurality of candidate neural network models based on a command transmitted by the electronic apparatus 100 may be clearly understood with reference to FIGS. 17 to 19.

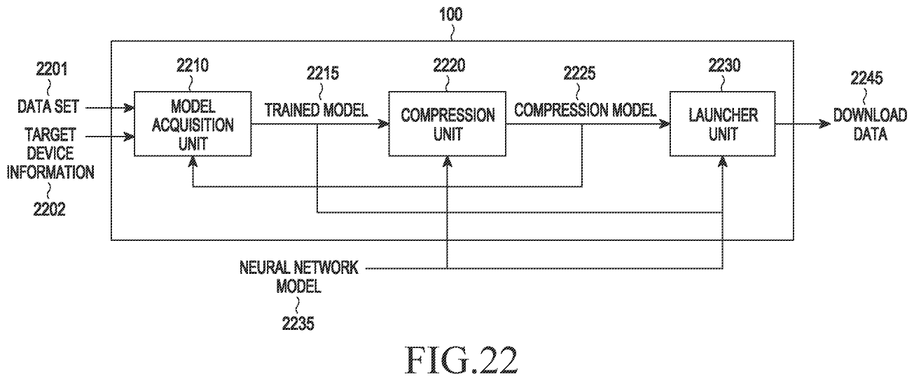

FIG. 22 is a diagram for describing an operation of an electronic apparatus according to an embodiment of the present disclosure.

Referring to FIG. 22, the electronic apparatus 100 may include a model acquisition unit 2210, a compression unit 2220, and a launcher unit 2230. The model acquisition unit 2210, the compression unit 2220, and the launcher unit 2230 may be implemented as a software module. The processor 130 may load and execute instructions related to each unit into the memory 120.

The model acquisition unit 2210 may acquire a trained model 2215 based on a data set 2201 and target device information 2202 (or information on the target device). For example, the model acquisition unit 2210 may perform a first project to acquire a first trained model. The model acquisition unit 2210 may receive a compressed model 2225 from the compression unit 2220. The model acquisition unit 2210 may acquire a retrained model by performing a third project configured based on the compressed model 2225.

The model acquisition unit 2210 may transmit the trained model 2215 to the compression unit 2220 or the launcher unit 2230. For example, the model acquisition unit 2210 may transmit the first trained model to the compression unit 2220. The model acquisition unit 2210 may transmit the retrained model to the launcher unit 2230. Other operations (e.g., an operation of performing a project) of the electronic apparatus 100 related to the model acquisition unit 2210 have been described above, and detailed descriptions thereof will be omitted.

The compression unit 2220 may output a lightweight model by performing compression on the input model. The compression unit 2220 may compress the trained model 2215 or a neural network model 2235 to generate the compressed model 2225. The neural network model 2235 may be a predetermined model that has not been acquired by the model acquisition unit 2210. The compression unit 2220 may transmit the compressed model 2225 to the launcher unit 2230 or the model acquisition unit 2210.

The compression unit 2220 may compress the input model based on the compression configuring information configured by the user. The compression configuring information may include at least one of a compression mode, a compression method, a compression configuring value, or reference information for determining a compression target among a plurality of channels included in the input model. The compression mode may include a first compression mode for the compression of the input model based on a model compression configuring value configured by a user for the compression of the input model. The compression mode may include a second compression mode that provides information on a block included in the input model to a user and compresses the trained model based on a block compression configuring value configured by the user for the block compression.

The launcher unit 2230 may output download data 2245 corresponding to the input model to be deployed on the target device. The model input to the launcher unit 2230 may include the compressed model 2225, the neural network model 2235, and a retrained model.

The launcher unit 2230 may perform quantization on the input model based on the target device information 2202. The target device information 2202 may include a data type (e.g., an 8-bit integer type) supported by the target device. The launcher unit 2230 may convert the data type of the input model into a data type supported by the target device.

The launcher unit 2230 may perform calibration on the input model. The launcher unit 2230 may perform calibration based on a code input by a user or a pre-stored code. For example, the launcher unit 2230 may adjust a quantization interval. The launcher unit 2230 may perform quantization based on the adjusted quantization interval. Accordingly, parameter values (e.g., weight values) of the input model or the quantized model may be changed.

The launcher unit 2230 may provide the download data 2245 to a user. The download data 2245 may mean a download file, a download package, or similar collection of data. When the user requests the download data 2245, the launcher unit 2230 may transmit the download data 2245 to the user device. Accordingly, a neural network model optimized for the target device may be installed in the user device.

Various exemplary embodiments of the present disclosure described above may be implemented in a computer or a computer readable recording medium using software, hardware, or a combination of software and hardware. In some cases, embodiments described in the present disclosure may be implemented as the processor itself. According to a software implementation, embodiments such as procedures and functions described in the disclosure may be implemented as separate software modules. Each of the software modules may perform one or more functions and operations described in the disclosure.

Computer instructions for performing processing operations according to the diverse embodiments of the disclosure described above may be stored in a non-transitory computer-readable medium. The computer instructions stored in the non-transitory computer-readable medium allow a specific machine to perform the processing operations according to the diverse embodiments described above when they are executed by a processor.

The non-transitory computer-readable medium is not a medium that stores data for a while, such as a register, a cache, a memory, or the like, but is a medium that semi-permanently stores data and is readable by the apparatus. A specific example of the non-transitory computer-readable medium may include a compact disk (CD), a digital versatile disk (DVD), a hard disk, a Blu-ray disk, a universal serial bus (USB), a memory card, a read only memory (ROM), or the like.

The machine-readable storage medium may be provided in the form of a non-transitory storage medium. Here, the “non-transitory storage medium” means that the storage medium is a tangible device, and does not include a signal (for example, electromagnetic waves), and the term does not distinguish between the case where data is stored semi-permanently on a storage medium and the case where data is temporarily stored thereon. For example, the “non-transitory storage medium” may include a buffer in which data is temporarily stored.

The methods according to the diverse embodiments disclosed in the document may be included and provided in a computer program product. The computer program product may be traded as a product between a seller and a purchaser. The computer program product may be distributed in the form of a machine-readable storage medium (for example, compact disc read only memory (CD-ROM)), or may be distributed (for example, download or upload) through an application store (for example, Play Store™) or may be directly distributed (for example, download or upload) between two user devices (for example, smart phones) online. In a case of the online distribution, at least some of the computer program products (for example, downloadable app) may be at least temporarily stored in a machine-readable storage medium such as a memory of a server of a manufacturer, a server of an application store, or a relay server or be temporarily created.

According to various embodiments of the present disclosure as described above, it is possible to provide a neural network model optimized for a target device.

According to various embodiments of the present disclosure as described above, it is possible to provide a neural network model trained based on a data set input by a user.

According to various embodiments of the present disclosure as described above, it is possible to provide a compressed neural network model based on a configuring value for compression input by a user.

According to various embodiments of the present disclosure as described above, it is possible to provide download data corresponding to the compressed neural network model.

Accordingly, it is possible to improve user convenience and satisfaction.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

It is contemplated that any optional feature of the inventive variations described may be set forth and claimed independently, or in combination with any one or more of the features described herein. It is further noted that the claims may be drafted to exclude any optional element for an embodiment. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

In addition, the effects that can be obtained or predicted by embodiments of the present disclosure have been disclosed directly or implicitly in the detailed description of the embodiments of the present disclosure. For example, various effects predicted according to the embodiments of the present disclosure have been disclosed in the above-described detailed description.

The embodiments described herein and the claims thereto are directed to patent eligible subject matter. These embodiments do not constitute abstract ideas for a myriad of reasons. One such reason is that any claim that provides for the ability of neural network optimization. These apparatuses and computer implemented methods allow for determination of a target device attributes and acquire and/or use a neural network model that is optimized for a target device and thereby constitute an improvement to the functioning of the computer itself, which may otherwise run sub-optimized neural networks and thus qualifies as “significantly more” than an abstract idea.

Other aspects, advantages, and prominent features of the present disclosure will become apparent to those skilled in the art from the above detailed description which discloses various embodiments of the present disclosure taken in conjunction with the accompanying drawings.

Although the embodiments of the disclosure have been illustrated and described hereinabove, the disclosure is not limited to the above-described specific embodiments, but may be variously modified by those skilled in the art to which the disclosure pertains without departing from the gist of the disclosure as disclosed in the accompanying claims. These modifications should also be understood to fall within the scope and spirit of the disclosure.

What is claimed is:

1. A method for providing information on a neural network model, performed by an electronic apparatus, comprising:
receiving, at a processor of the electronic apparatus, information on a target device on which the neural network model will be executed and target performance of the neural network model for the target device from an external device;
deriving, by the processor, information on a plurality of candidate neural network models based on the information on the target device and the received target performance; and
transmitting, via a computer network, a command to the external device to display information on the plurality of candidate neural network models based on the received target performance, wherein the information on the plurality of candidate neural network models includes at least one of name of the plurality of candidate neural network models, performance of the plurality of candidate neural network models, or size of input data of the plurality of candidate neural network models,
wherein, when a training mode for deriving the plurality of candidate neural network models is configured as a first training mode,
a plurality of UI elements each representing information on a respective one of the plurality of candidate neural network models include:
first UI elements each corresponding to a respective one of a plurality of first candidate neural network models derived based on size of input data, the size of input data being configured by a user, and
second UI elements each corresponding to a respective one of a plurality of second candidate neural network models derived based on target performance, the target performance being configured by the user, and
the first UI elements and the second UI elements are displayed in different areas, and
wherein, when the training mode is configured as a second training mode,
the plurality of UI elements are displayed on a two-dimensional graph defined by a first axis corresponding to a first performance parameter and a second axis corresponding to a second performance parameter, the second axis being perpendicular to the first axis.

2. The method of claim 1, wherein, when the training mode is configured as the first training mode,
the plurality of UI elements are displayed in increasing order of difference between the performance of the candidate neural network model corresponding to each of the plurality of UI elements and the received target performance.

3. The method of claim 1, wherein the first performance parameter is a latency, and the second performance parameter is an accuracy.

4. The method of claim 1,
wherein the plurality of UI elements include third UI elements each corresponding to a respective one of a plurality of third candidate neural network models having performance within a predetermined range from the received target performance, and fourth UI elements each corresponding to a respective one of a plurality of fourth candidate neural network models having performances outside the predetermined range from the received target performance, and
wherein the transmitting includes transmitting a command to the external device to activate the third UI elements and deactivate the fourth UI elements.

5. The method of claim 1, wherein each of the plurality of UI elements displays information on a respective one of the plurality of candidate neural network models when selected by a user.

6. The method of claim 1, wherein the information on the plurality of candidate neural network models is obtained based on a look-up table, and
wherein the look-up table includes identification information of a plurality of neural network models, information on a plurality of devices on which the plurality of neural network models are executed, and performance information of the plurality of neural network models for the plurality of devices.

7. The method of claim 6, wherein the deriving includes deriving information on neural network models whose rankings are higher than or equal to a predetermined ranking among the plurality of neural network models, the rankings being based on performance differences from the target performance.

8. The method of claim 6, wherein the deriving includes deriving information on neural network models whose performance difference from the target performance is within a preset range among the plurality of neural network models.

9. An electronic apparatus for providing information on a neural network model
a communication interface, configured to transmit and receive data via a data network, including at least one communication circuit;
a non-transitory memory configured to store at least one operation instruction; and
a processor,
wherein execution of the at least one operation instruction causes the processor to:
receive information on a target device on which the neural network model will be executed and target performance of the neural network model for the target device from an external device;
derive information on a plurality of candidate neural network models based on the information on the target device and the received target performance; and
transmit a command to the external device to display information on the plurality of candidate neural network models based on the received target performance, wherein the information on the plurality of candidate neural network models includes at least one of name of the plurality of candidate neural network models, performance of the plurality of candidate neural network models, or size of input data of the plurality of candidate neural network models,
wherein, when a training mode for deriving the plurality of candidate neural network models is configured as a first training mode,
a plurality of UI elements each representing information on a respective one of the plurality of candidate neural network models include:
first UI elements each corresponding to a respective one of the plurality of first candidate neural network models derived based on size of input data, the size of input data being configured by the user and
second UI elements each corresponding to a respective one of the plurality of second candidate neural network models derived based on target performance, the target performance being configured by a user, and
the first UI elements and the second UI elements are displayed in different areas, and
wherein, when the training mode is configured as a second training mode,
the plurality of UI elements are displayed on a two-dimensional graph defined by a first axis corresponding to a first performance parameter and a second axis corresponding to a second performance parameter, the second axis being perpendicular to the first axis.

10. The electronic apparatus of claim 9, wherein, wherein, when the training mode is configured as the first training mode,
the plurality of UI elements are displayed in increasing order of difference between the performance of the candidate neural network model corresponding to each of the plurality of UI elements and the received target performance.

11. The electronic apparatus of claim 9, wherein the first performance parameter is a latency, and the second performance parameter is an accuracy.

12. The electronic apparatus of claim 9,
wherein the plurality of UI elements include third UI elements each corresponding to a respective one of a plurality of third candidate neural network models having performance within a predetermined range from the received target performance, and fourth UI elements each corresponding to a respective one of a plurality of fourth candidate neural network models having performances outside the predetermined range from the received target performance, and
wherein the processor is further configured to control the communication interface to transmit a command to the external device to activate the third UI elements and deactivate the fourth UI elements.

13. The electronic apparatus of claim 9, the processor is further configured to derive the information on the plurality of candidate neural network models based on a look-up table, and
wherein the look-up table includes identification information of a plurality of neural network models, information on a plurality of devices on which the plurality of neural network models are executed, and performance information of the plurality of neural network models for the plurality of devices.

14. The electronic apparatus of claim 13, the processor is further configured to derive information on neural network models whose rankings are higher than or equal to a predetermined ranking among the plurality of neural network models, the rankings being based on performance differences from the target performance.

15. The electronic apparatus of claim 13, the processor is further configured to derive information on neural network models whose performance difference from the target performance is within a preset range among the plurality of neural network models.
